(19) United States
(12) Patent Application Publication
(10) Pub. No.: US 2018/0059049 A1
(43) Pub. Date: Mar. 1, 2018

(54) GEL SENSOR AND COMPONENT CONCENTRATION ESTIMATION METHOD

(71) Applicant: Seiko Epson Corporation, Tokyo (JP)

(72) Inventor: Jun TAKIZAWA, Chino (JP)

(21) Appl. No.: 15/673,677

(22) Filed: Aug. 10, 2017

(30) Foreign Application Priority Data
Aug. 23, 2016 (JP) 2016-162490

(51) Int. Cl. G01N 27/416

(52) U.S. Cl. CPC G01N 27/416

(57) ABSTRACT

A lactic acid measurement device includes a stimulus-responsive gel in the form of a gel which reacts with lactic acid contained in sweat and changes its impedance, an electrical property detection part which detects the impedance of the stimulus-responsive gel, and a concentration estimation part which estimates the concentration of lactic acid contained in sweat from the time-series change in the impedance.

### BACKGROUND

### 1. Technical Field

The present invention relates to a gel sensor and a component concentration estimation method.

### 2. Related Art

In muscles of living organisms, pyruvic acid is contained. When a muscle performs an anaerobic exercise, pyruvic acid is converted to lactic acid. If oxygen is lacking in a tissue near a sweat gland when a muscle performs an exercise, the concentration of lactic acid in sweat increases. Therefore, it is possible to detect whether or not the supply of oxygen to the muscle is sufficient by detecting the concentration of lactic acid in sweat. Muscle endurance is improved by an exercise. A relationship between the concentration of lactic acid in sweat at this time and an exercise intensity has been studied.

A detection device which detects a substance contained in sweat excreted on the surface of the skin is disclosed in JP-A-2009-247440 (Patent Document 1). According to this, this detection device includes a reaction part which reacts with a substance in sweat and a liquid transport part which transports sweat to the reaction part. The reaction part includes electrodes and an enzyme, and the enzyme reacts with a component contained in sweat. Then, the electrical property of the enzyme changes. The detection device applies a voltage between the electrodes and detects the change in the electric current flowing between the electrodes.

As a medium for fixing a reactant such as an enzyme which reacts with a component contained in sweat to the electrodes, a gel is used. At this time, it takes time for sweat to permeate the gel so that the sweat reaches the reactant. After permeating the gel, the component contained in the sweat and the reactant react with each other. The reaction between the component contained in the sweat and the reactant is a chemical reaction, and the reaction takes time. In order to detect the concentration of the component contained in the sweat, it is necessary to wait until the reaction part containing the reactant and sweat completely react with each other. Therefore, a gel sensor capable of estimating the concentration of a predetermined component contained in a test liquid such as sweat in a shorter time than when the test liquid and the reaction part completely react with each other has been demanded.

### SUMMARY

An advantage of some aspects of the invention is to solve the problem described above and the invention can be implemented as the following modes or application examples.

### Application Example 1

A gel sensor according to this application example includes a reaction part in the form of a gel which reacts with a predetermined component contained in a test liquid and changes its electrical property, an electrical property detection part which detects the electrical property of the reaction part, and a concentration estimation part which estimates the concentration of the predetermined component contained in the test liquid from the time-series change in the electrical property.

According to this application example, the gel sensor includes a reaction part, an electrical property detection part, and a concentration estimation part. The reaction part is in the form of a gel and absorbs a test liquid. Then, the reaction part reacts with a predetermined component contained in the test liquid. The reaction part reacts with the predetermined component and changes its electrical property. The electrical property detection part detects the electrical property of the reaction part. By detecting the electrical property, the degree at which the reaction part reacts with the predetermined component can be detected.

When the concentration of the predetermined component contained in the test liquid is high, the reaction proceeds more quickly than when the concentration thereof is low, and therefore, the electrical property changes more quickly. That is, the speed at which the electrical property changes and the concentration of the predetermined component contained in the test liquid have a predetermined correlation. The concentration estimation part detects the speed at which the electrical property changes from the time-series change in the electrical property and estimates the concentration of the predetermined component contained in the test liquid from the speed at which the electrical property changes. At this time, the concentration estimation part estimates the concentration of the predetermined component contained in the test liquid before the reaction part completely reacts with the test liquid. Therefore, the concentration of the predetermined component contained in the test liquid can be estimated in a shorter time than when the reaction part completely reacts with the test liquid.

### Application Example 2

In the gel sensor according to the above application example, it is preferred that the gel sensor includes a supply detection part which detects whether or not the test liquid is supplied to the reaction part.

According to this application example, the gel sensor includes a supply detection part, and the supply detection part detects whether or not the test liquid is supplied to the reaction part. Then, the supply detection part detects that the supply of the test liquid is started. The concentration estimation part estimates the concentration of the predetermined component using the time-series change in the electrical property from when the reaction part starts the reaction. The concentration estimation part does not refer to the time-series change before the supply of the test liquid is started, and therefore, the time-series change in the electrical property due to the reaction of the test liquid can be accurately detected.

### Application Example 3

In the gel sensor according to the above application example, it is preferred that irregularities are provided on the surface of the reaction part.

According to this application example, irregularities are provided on the surface of the reaction part. Therefore, the surface area of the surface of the reaction part becomes larger than in the case where irregularities are not provided. When the surface area is large, the area where the test liquid comes in contact with the reaction part is large, and therefore, the test liquid is more likely to react with the reaction part. Accordingly, the reaction part reacts with the test liquid more quickly, and thus, the concentration estimation part can detect the time-series change in the electrical property in a short time.

### Application Example 4

In the gel sensor according to the above application example, it is preferred that the gel sensor includes a recovery part which recovers the test liquid, and a transport part which transports the test liquid to the reaction part from the recovery part, and the recovery part includes a recovery detection part which detects whether or not the test liquid is recovered.

According to this application example, the gel sensor includes a recovery part and a transport part. The recovery part recovers the test liquid. Then, the transport part transports the test liquid to the reaction part from the recovery part. In the recovery part, a recovery detection part is provided, and the recovery detection part detects whether or not the test liquid is recovered. When the recovery detection part detects that the test liquid is not recovered in the recovery part, it is not necessary to operate the transport part, the supply detection part, and the electrical property detection part, and therefore, it is possible to suppress the power consumption of the transport part, the supply detection part, and the electrical property detection part.

### Application Example 5

In the gel sensor according to the above application example, it is preferred that the gel sensor includes a passage detection part which detects whether or not a portion of the test liquid supplied to the reaction part passes through the reaction part.

According to this application example, the gel sensor includes a passage detection part, and the passage detection part detects whether or not a portion of the test liquid passes through the reaction part. When a portion of the test liquid passes through the reaction part, a portion of the test liquid is retained in the reaction part. Therefore, by stopping the transport of the test liquid by the transport part when a portion of the test liquid passes through the reaction part, a portion of the test liquid can be retained in the reaction part. Accordingly, even if the amount of the test liquid is small, the test liquid can be reacted with the reaction part.

### Application Example 6

In the gel sensor according to the above application example, it is preferred that the gel sensor includes a flow channel, in which the reaction part is placed, and through which the test liquid flows, and the flow channel has a streamlined shape.

According to this application example, the gel sensor includes a flow channel, through which the test liquid flows. In the flow channel, the reaction part is placed. The flow channel has a streamlined shape. At this time, the test liquid flows against a small resistance, and therefore, the test liquid can be made to flow by a small pressure difference.

### Application Example 7

In the gel sensor according to the above application example, it is preferred that the recovery part includes an air intake hole through which outside air passes.

According to this application example, in the recovery part, an air intake hole through which outside air passes is provided. The air intake hole also includes a groove through which outside air can pass. When the transport part transports the test liquid located in the recovery part to the reaction part, outside air enters the recovery part. Accordingly, the atmospheric pressure in the recovery part does not decrease, and therefore, the transport part can easily transport the test liquid to the reaction part.

### Application Example 8

In the gel sensor according to the above application example, it is preferred that a plurality of reaction parts are provided, and a switching part which switches the reaction part to which the test liquid is supplied is included.

According to this application example, a plurality of reaction parts are provided in the gel sensor. Then, the gel sensor includes a switching part, and the switching part switches the reaction part to which the test liquid is supplied. Accordingly, the concentration of the predetermined component contained in the test liquid can be detected a plurality of times without replacing the reaction part.

### Application Example 9

A component concentration estimation method according to this application example includes supplying a test liquid to a reaction part in the form of a gel which reacts with a predetermined component contained in the test liquid and changes its electrical property, detecting the electrical property of the reaction part, and estimating the concentration of the predetermined component contained in the test liquid from the time-series change in the electrical property.

According to this application example, the reaction part is in the form of a gel and absorbs a test liquid. Then, the reaction part reacts with a predetermined component contained in the test liquid. The reaction part reacts with the predetermined component and changes its electrical property. To this reaction part, the test liquid is supplied. Then, the electrical property of the reaction part is detected. By detecting the electrical property, the degree at which the reaction part reacts with the predetermined component can be detected.

When the concentration of the predetermined component contained in the test liquid is high, the reaction proceeds more quickly than when the concentration thereof is low, and therefore, the electrical property changes more quickly. That is, the speed at which the electrical property changes and the concentration of the predetermined component contained in the test liquid have a predetermined correlation. The concentration estimation part detects the speed at which the electrical property changes from the time-series change in the electrical property and estimates the concentration of the predetermined component contained in the test liquid from the speed at which the electrical property changes. At this time, the concentration estimation part estimates the concentration of the predetermined component contained in the test liquid before the reaction part completely reacts with the test liquid. Therefore, the concentration of the predetermined component contained in the test liquid can be estimated in a shorter time than when the reaction part completely reacts with the test liquid.

### BRIEF DESCRIPTION OF THE DRAWINGS

The invention will be described with reference to the accompanying drawings, wherein like numbers reference like elements.

FIG. 1 is a schematic view for illustrating an example of placement of a lactic acid measurement device according to a first embodiment.

FIG. 2 is a schematic plan view showing the structure of the lactic acid measurement device.

FIG. 3 is a schematic plan view showing the structure of the lactic acid measurement device.

FIG. 4 is a schematic side cross-sectional view showing the structure of the lactic acid measurement device.

FIG. 5 is a schematic plan view showing the structure of the lactic acid measurement device.

FIG. 6 is a schematic plan view showing the structure of an electrical property detection part.

FIG. 7 is a schematic side cross-sectional view of a principal part showing the structure of a flow channel.

FIG. 8 is a schematic side cross-sectional view of a principal part showing the structure of the flow channel.

FIG. 9 is a schematic side cross-sectional view for illustrating the structure of a back cover.

FIG. 10 is a block diagram for the electrical control of the lactic acid measurement device.

FIG. 11 is a view for illustrating the structure of an impedance measurement part.

FIG. 12 is a schematic view for illustrating an electric field in an electrical property detection part.

FIG. 13 is a flowchart of a component concentration estimation method.

FIG. 14 is a schematic view for illustrating the component concentration estimation method.

FIG. 15 is a schematic view for illustrating the component concentration estimation method.

FIG. 16 is a schematic view for illustrating the component concentration estimation method.

FIG. 17 is a schematic view for illustrating the component concentration estimation method.

FIG. 18 is a schematic view for illustrating the component concentration estimation method.

FIG. 19 is a schematic view for illustrating the component concentration estimation method.

FIG. 20 is a schematic side cross-sectional view showing the structure of a lactic acid measurement device according to a second embodiment.

FIG. 21 is a schematic plan view showing the structure of the lactic acid measurement device.

### DESCRIPTION OF EXEMPLARY EMBODIMENTS

Hereinafter, embodiments will be described with reference to the accompanying drawings. Incidentally, the respective members in the respective drawings are shown by changing the scale for each member so as to have a recognizable size in the respective drawings.

### First Embodiment

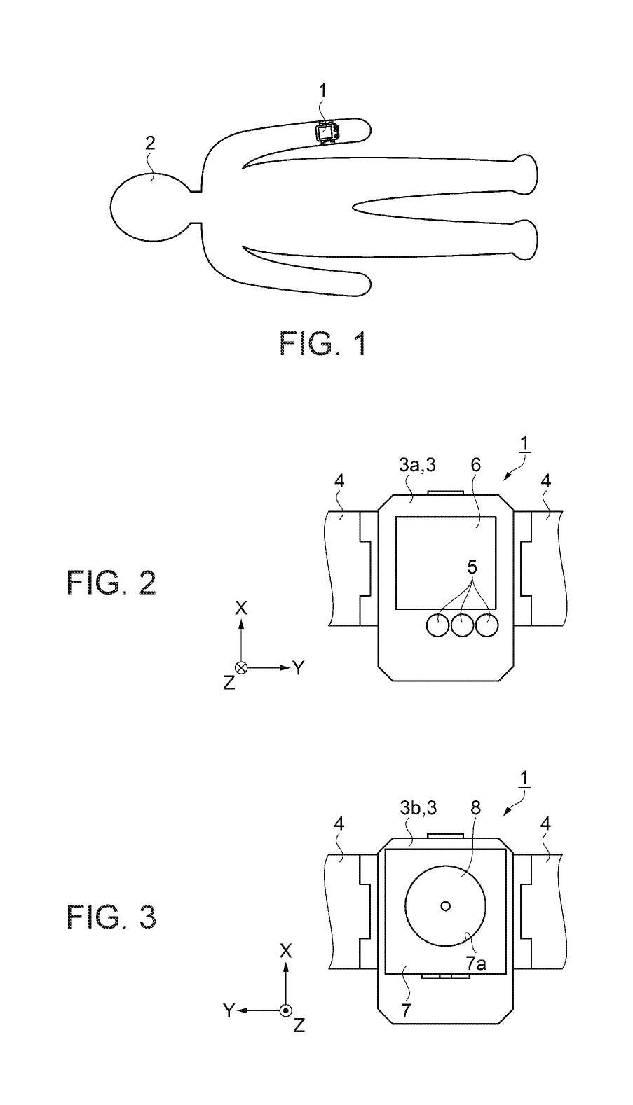

In this embodiment, characteristic examples of a lactic acid measurement device and a lactic acid measurement method for measuring the concentration of lactic acid contained in sweat using the lactic acid measurement device will be described with reference to the drawings. A lactic acid measurement device according to the first embodiment will be described with reference to FIGS. 1 to 12. FIG. 1 is a schematic view for illustrating an example of placement of a lactic acid measurement device. As shown in FIG. 1, a lactic acid measurement device 1 as a gel sensor is placed on the wrist of a test subject 2. The lactic acid measurement device 1 is a measurement device for medical use, with which the concentration of lactic acid contained in sweat of the test subject 2 is measured, and is a medical device. The lactic acid measurement device 1 measures sweat excreted from the wrist. Therefore, the test liquid to be tested by the lactic acid measurement device 1 is sweat, and the predetermined component is lactic acid.

FIGS. 2 and 3 are each a schematic plan view showing the structure of the lactic acid measurement device. FIG. 2 shows the front surface of the lactic acid measurement device 1, and FIG. 3 shows the back surface of the lactic acid measurement device 1. As shown in FIG. 2, the lactic acid measurement device 1 has a similar form to that of a watch. The lactic acid measurement device 1 includes an outer package part 3. On the right and left sides of the outer package part 3 in the drawing, a fixing band 4 is provided, and the fixing band 4 fixes the lactic acid measurement device 1 to a measurement part such as a wrist or an arm of the test subject 2. As the fixing band 4, a magic tape (registered trademark) is used. In the lactic acid measurement device 1, the direction in which the fixing band 4 extends is referred to as “Y direction”, and the direction in which the arm of the test subject 2 extends is referred to as “X direction”. The direction in which the lactic acid measurement device 1 faces the wrist of the test subject 2 is referred to as “Z direction”. The X direction, the Y direction, and the Z direction are orthogonal to one another.

A front surface 3a of the outer package part 3 is a surface facing outward when the device is attached to the test subject 2. On the front surface 3a of the outer package part 3, an operation switch 5 and a display part 6 are provided. The test subject 2 inputs a measurement start instruction using the operation switch 5. Then, the data of measurement results is displayed on the display part 6.

As shown in FIG. 3, on a back surface 3b side of the outer package part 3, a back cover 7 is provided, and in the back cover 7, an opening 7a is provided. In the inside of the lactic acid measurement device 1, a sensor module 8 is provided, and the sensor module 8 is exposed from the opening 7a. The sensor module 8 is made to face the skin of the test subject 2 and is used. The sensor module 8 is a device which detects lactic acid as the predetermined component contained in sweat excreted from the skin of the test subject 2. The skin is a test surface for the lactic acid measurement device 1. The sensor module 8 is a module including a chemical agent in the form of a gel which reacts with lactic acid.

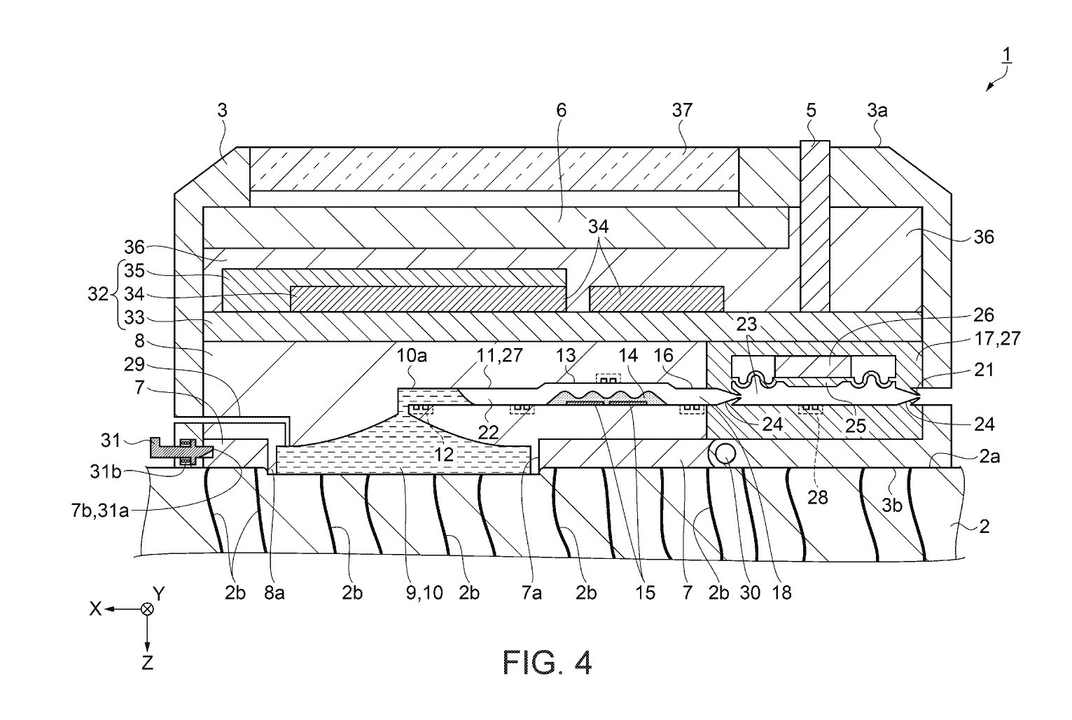

FIG. 4 is a schematic side cross-sectional view showing the structure of the lactic acid measurement device. As shown in FIG. 4, the lactic acid measurement device 1 is attached to the test subject 2 so that the back surface 3b of the outer package part 3 and the back cover 7 are in contact with the test subject 2. The surface of the test subject 2 when the back cover 7 comes in contact with the test subject 2 is refers to as “test surface 2a”. The test surface 2a is the surface of the skin in which a sweat gland 2b is located. From the sweat gland 2b of the test subject 2, sweat 9 as the test liquid is secreted. In the sensor module 8, a concave part 10 is provided as a recovery part in a place where the sensor module 8 is exposed from the opening 7a. The concave part 10 has a conical shape which opens to the +Z direction side. When the sweat 9 is excreted from the sweat gland 2b, a portion of the sweat 9 is retained in the concave part 10.

On the −Z direction side of the concave part 10, a reaction part upstream flow channel 11 through which the sweat 9 flows is provided. The reaction part upstream flow channel 11 extends in the X direction. Then, between the concave part 10 and the reaction part upstream flow channel 11, a flow channel connection part 10a is provided. The concave part 10 and the flow channel connection part 10a constitute a recovery part which recovers the sweat 9. In the flow channel connection part 10a, a recovery detection part 12 is provided, and the recovery detection part 12 detects whether or not the sweat 9 is recovered. The recovery detection part 12 includes a pair of electrodes. When the sweat 9 is not present between the electrodes, a resistance value between the electrodes is high, and when the sweat 9 is present between the electrodes, a resistance value between the electrodes is low. Therefore, by detecting the resistance between the electrodes, whether or not the sweat 9 is present in the recovery detection part 12 can be detected.

On the −X direction side of the reaction part upstream flow channel 11, a reaction part flow channel 13 as a flow channel is provided and connected to the reaction part upstream flow channel 11. The sweat 9 passing through the reaction part upstream flow channel 11 flows through the reaction part flow channel 13. In the reaction part flow channel 13, a stimulus-responsive gel 14 in the form of a gel as the reaction part is provided. When the sweat 9 reaches the stimulus-responsive gel 14, the sweat 9 permeates the stimulus-responsive gel 14. Then, the stimulus-responsive gel 14 reacts with lactic acid contained in the sweat 9 and changes its electrical property. In the inside of the stimulus-responsive gel 14, an electrical property detection part 15 which detects the electrical property of the stimulus-responsive gel 14 is provided.

The change in the electrical property of the stimulus-responsive gel 14 appears as the electrical conductivity and the dielectricity. When the stimulus-responsive gel 14 swells, both electrical conductivity and dielectricity of the stimulus-responsive gel 14 increase. This is caused by an increase in free water due to the swelling of the stimulus-responsive gel 14. The swelling phenomenon can be ascertained by using either of the electrical conductivity and the dielectricity, however, the change in the dielectricity is small, and therefore, the change in the electrical conductivity is used.

The stimulus-responsive gel 14 is in the form of a gel containing a chemical agent which reacts with sweat. The constituent material of the stimulus-responsive gel 14 is not particularly limited, however, in this embodiment, the stimulus-responsive gel 14 is constituted by a material containing, for example, a polymer material having a crosslinked structure and a solvent, or the like. The polymer material serves as the chemical agent which reacts with sweat.

As the polymer material constituting the stimulus-responsive gel 14, for example, a polymer material obtained by reacting a monomer, a polymerization initiator, a crosslinking agent, etc. can be used.

Examples of the monomer include acrylamide, N-methylacrylamide, N-isopropylacrylamide, N,N-dimethylacrylamide, N,N-dimethylaminopropylacrylamide, various quaternary salts of N,N-dimethylaminopropylacrylamide, acryloylmorpholine, various quaternary salts of N,N-dimethylaminoethylacrylate, acrylic acid, various alkyl acrylates, methacrylic acid, various alkyl methacrylates, 2-hydroxyethylmethacrylate, glycerol monomethacrylate, N-vinylpyrrolidone, acrylonitrile, styrene, polyethylene glycol diacrylate, 1,6-hexanediol diacrylate, neopentyl glycol diacrylate, tripropylene glycol diacrylate, polypropylene glycol diacrylate, 2,2-bis[4-(acryloxydiethoxy)phenyl]propane, 2,2-bis[4-(acryloxypolyethoxy)phenyl]propane, 2-hydroxy-1-acryloxy-3-methacryloxypropane, 2,2-bis[4-(acryloxypolypropoxy)phenyl]propane, ethylene glycol dimethacrylate, diethylene glycol dimethacrylate, triethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2-hydroxy-1,3-dimethacryloxypropane, 2,2-bis[4-(methacryloxyethoxy)phenyl]propane, 2,2-bis[4-(methacryloxyethoxydiethoxy)phenyl]propane, 2,2-bis[4-(methacryloxyethoxypolyethoxy)phenyl]propane, trimethylolpropane trimethacrylate, tetramethylolmethane trimethacrylate, trimethylolpropane triacrylate, tetramethylolmethane triacrylate, tetramethylolmethane tetraacrylate, dipentaerythritol hexaacrylate, N,N′-methylenebisacrylamide, N,N′-methylenebismethacrylamide, diethylene glycol diallyl ether, and divinylbenzene.

As the monomer for detecting lactic acid, 3-acrylamidophenylboronic acid, vinylphenylboronic acid, acryloyloxyphenylboronic acid, N-isopropylacrylamide (NIPAAm), ethylenebisacrylamide, N-hydroxyethylacrylamide, or the like can be preferably used. Specifically, it is preferred to use one monomer or two or more monomers selected from the group consisting of 3-acrylamidophenylboronic acid, vinylphenylboronic acid, and acryloyloxyphenylboronic acid, and one monomer or two or more monomers selected from the group consisting of N-isopropylacrylamide (NIPAAm), ethylenebisacrylamide, and N-hydroxyethylacrylamide in combination as the monomer.

The polymerization initiator can be appropriately selected according to, for example, the polymerization method thereof. Specifically, as the polymerization initiator, a compound which generates radicals by ultraviolet light such as hydrogen peroxide, a persulfate, for example, potassium persulfate, sodium persulfate, ammonium persulfate, or the like, an azo-based initiator, for example, 2,2′-azobis(2-amidinopropane) dihydrochloride, 2,2′-azobis(N,N′-dimethyleneisobutylamidine) dihydrochloride, 2,2′-azobis{2-methyl-N-[1,1-bis(hydroxymethyl)-2-hydroxyethyl]propionamide}, 2,2′-azobis[2-(2-imidazolin-2-yl)propane]dihydrochloride, 4,4′-azobis(4-cyanovaleric acid), 2,2′-azobisisobutyronitrile, 2,2′-azobis(2,4′-dimethylvaleronitrile), benzophenone, 2,2-dimethoxy-1,2-diphenylethan-1-one, 1-hydroxycyclohexyl phenyl ketone, 2-hydroxy-2-methyl-1-phenylpropan-1-one, 2,4,6-trimethylbenzoyl diphenylphosphine oxide, 1-[4-(2-hydroxyethoxy)-phenyl]-2-hydroxy-2-methyl-1-propan-1-one, or the like, a compound which generates radicals by light with a wavelength of 360 nm or more such as a substance obtained by mixing a thiopyrylium salt-based, merocyanine-based, quinoline-based, or styrylquinoline-based dye with 2,4-diethyl thioxanthone, isopropyl thioxanthone, 1-chloro-4-propoxythioxanthone, 2-(3-dimethylamino-2-hydroxypropoxy)-3,4-dimethyl-9H-thioxanthon-9-one methochloride, 2-methyl-1[4-(methylthio)phenyl]-2-morpholinopropane-1,2-benzyl-2-dimethylamino-1-(4-morpholinophenyl)-butanone-1, bis(cyclopentadienyl)-bis(2,6-difluoro-3-(pyl-1-yl) titanium, or a peroxy ester such as 1,3-di(t-butylperoxycarbonyl)benzene or 3,3′,4,4′-tetra-(t-butylperoxycarbonyl) benzophenone, or the like can be used. Further, hydrogen peroxide or a persulfate can also be used as a redox-based initiator in combination with, for example, a reducing substance such as a sulfite or L-ascorbic acid, an amine salt, or the like.

As the crosslinking agent, a compound having two or more polymerizable functional groups can be used, and specifically, ethylene glycol, propylene glycol, trimethylolpropane, glycerin, polyoxyethylene glycol, polyoxypropylene glycol, polyglycerin, N,N′-methylenebisacrylamide, N,N-methylene-bis-N-vinylacetamide, N,N-butylene-bis-N-vinylacetamide, tolylene diisocyanate, hexamethylene diisocyanate, allylated starch, allylated cellulose, diallyl phthalate, tetraallyloxyethane, pentaerythritol triallyl ether, trimethylolpropane triallyl ether, diethylene glycol diallyl ether, triallyl trimellitate, or the like can be used.

The stimulus-responsive gel may contain a plurality of different types of polymer materials. The content of the polymer material in the stimulus-responsive gel is preferably 0.7 mass % or more and 36.0 mass % or less, more preferably 2.4 mass % or more and 27.0 mass % or less.

By configuring the stimulus-responsive gel 14 to contain a solvent, the polymer material can be favorably gelled. As the solvent, any of various types of organic solvents and inorganic solvents can be used. Specific examples of the solvent include water; various types of alcohols such as methanol and ethanol; ketones such as acetone; ethers such as tetrahydrofuran and diethyl ether; amides such as dimethylformamide; chain aliphatic hydrocarbons such as n-pentane, n-hexane, n-heptane, and n-octane; alicyclic hydrocarbons such as cyclohexane and methylcyclohexane; and aromatics such as benzene, toluene, and xylene, however, in particular, a solvent containing water is preferred.

The stimulus-responsive gel 14 may be configured to contain a plurality of different types of components as the solvent. The content of the solvent in the stimulus-responsive gel 14 is preferably 30 mass % or more and 95 mass % or less, more preferably 50 mass % or more and 90 mass % or less.

The size of the stimulus-responsive gel 14 is not particularly limited, however, in this embodiment, for example, the diameter of the stimulus-responsive gel 14 is 2 to 3 mm, and the thickness of the stimulus-responsive gel 14 is 100 μm. When the stimulus-responsive gel 14 is produced, a container is used. The monomer, the polymerization initiator, the crosslinking agent, etc. are fed to a container and reacted with one another. By accurately weighing the amounts of the materials to be fed, the stimulus-responsive gel 14 can be formed to a desired thickness with high accuracy.

The stimulus-responsive gel 14 has a polymer chain. In the polymer chain, many boronic acid groups are included. When lactic acid does not permeate the stimulus-responsive gel 14, the stimulus-responsive gel 14 is in a state where the boronic acid groups are bound to each other so that the polymer chains come close to each other. Due to this, the stimulus-responsive gel 14 is in a contracted state. When lactic acid permeates the stimulus-responsive gel 14, the boronic acid group and lactic acid are bound to each other. Then, when the stimulus-responsive gel 14 reacts with lactic acid, the stimulus-responsive gel 14 is in a state where the polymer chains are dissociated from each other, and therefore, the volume of the stimulus-responsive gel 14 expands. The form of the stimulus-responsive gel 14 changes, and therefore, the electrical conductivity of the stimulus-responsive gel 14 changes.

The stimulus-responsive gel 14 further contains fine particles having a high reflectivity. When lactic acid is incorporated in the stimulus-responsive gel 14, a structural color due to colloidal crystals and a change in the structural color are easily visually recognized. Therefore, the concentration of lactic acid can be more easily detected. In addition, the concentration of lactic acid can be easily and accurately estimated by the color tone of the stimulus-responsive gel 14. In this embodiment, for example, when the concentration of lactic acid contained in the stimulus-responsive gel 14 is low, the stimulus-responsive gel 14 has a bluish color, and when the concentration of lactic acid increases, the color changes to red.

Examples of the constituent material of the fine particles include inorganic materials such as silica and titanium oxide; and organic materials such as polystyrene, polyester, polyimide, polyolefin, poly(methyl (meth)acrylate), polyethylene, polypropylene, polyether sulfone, nylon, polyurethane, polyvinyl chloride, and polyvinylidene chloride. The fine particles are preferably silica fine particles. According to this, the shape stability and the like of the fine particles are made particularly excellent, and the durability, reliability, and the like of the stimulus-responsive gel can be made particularly excellent. In addition, the silica fine particles are relatively easily available as monodispersed fine particles having a sharp particle size distribution, and therefore are advantageous also from the viewpoint of stable production and supply of the stimulus-responsive gel.

The shape of the fine particle is not particularly limited, but is preferably a spherical shape. According to this, the structural color due to the colloidal crystals or the change in the structural color is easily visually recognized, and therefore, the detection of a specific component can be more easily performed. The average particle diameter of the fine particles is not particularly limited, but is preferably 10 nm or more and 1000 nm or less, more preferably 20 nm or more and 500 nm or less.

According to this, when a specific component is incorporated in the stimulus-responsive gel, the structural color due to the colloidal crystals or the change in the structural color is more easily visually recognized, and therefore, the detection of a specific component can be more easily performed. In addition, since the structural color due to the colloidal crystals is more easily visually recognized, the quantitative determination of a specific component can also be more easily and accurately performed by the color tone.

As the average particle diameter, the average particle diameter on a volume basis is shown. For example, the measurement is performed using a particle size distribution analyzer employing a Coulter counter method for a dispersion liquid obtained by adding a sample to methanol and dispersing the sample therein for 3 minutes with an ultrasonic disperser. At this time, the average particle diameter of the sample can be obtained by performing the measurement using an aperture of 50 μm.

The stimulus-responsive gel 14 may contain a plurality of different types of fine particles. The content of the fine particles in the stimulus-responsive gel is preferably 1.6 mass % or more and 36 mass % or less, more preferably 4.0 mass % or more and 24 mass % or less.

On the −X direction side of the reaction part flow channel 13, a reaction part downstream flow channel 16 is provided and connected to the reaction part flow channel 13. The sweat 9 passing through the reaction part flow channel 13 flows through the reaction part downstream flow channel 16. In the sensor module 8, the concave part 10, the flow channel connection part 10a, the reaction part upstream flow channel 11, the reaction part flow channel 13, the stimulus-responsive gel 14, the reaction part downstream flow channel 16, etc. are provided.

On the −X direction side of the sensor module 8, a pump 17 is provided. The pump 17 includes an input part 18 and an output part 21, and the input part 18 is connected to the reaction part downstream flow channel 16. The pump 17 sucks the sweat 9 and air 22 in the reaction part upstream flow channel 11, the reaction part flow channel 13, and the reaction part downstream flow channel 16 from the input part 18 side and discharges them from the output part 21.

The pump 17 includes a pressure chamber 23 connected to the input part 18 and the output part 21. Between the input part 18 and the pressure chamber 23, a valve 24 is provided. The sweat 9 and the air 22 flow from the input part 18 to the pressure chamber 23, and do not flow from the pressure chamber 23 to the input part 18. Similarly, between the pressure chamber 23 and the output part 21, a valve 24 is provided. The sweat 9 and the air 22 flow from the pressure chamber 23 to the output part 21, and do not flow from the output part 21 to the pressure chamber 23.

On the −Z direction side of the pressure chamber 23, a diaphragm 25 is provided, and on the −Z direction side of the diaphragm 25, a piezoelectric element 26 is provided. The volume of the pressure chamber 23 changes by the contraction of the piezoelectric element 26. When the volume of the pressure chamber 23 increases, the sweat 9 and the air 22 flow in the pressure chamber 23 from the input part 18. When the volume of the pressure chamber 23 decreases, the sweat 9 and the air 22 flow in the output part 21 from the pressure chamber 23. In this manner, the pump 17 allows the sweat 9 and the air 22 to flow.

By the reaction part upstream flow channel 11 and the pump 17, a transport part 27 is constituted. The lactic acid measurement device 1 includes the concave part 10 and the transport part 27. The concave part 10 recovers the sweat 9. Then, the transport part 27 transports the sweat 9 to the stimulus-responsive gel 14 from the concave part 10. In the pressure chamber 23, an in-pump detection part 28 is provided, and the in-pump detection part 28 detects whether or not the sweat 9 is present in the pressure chamber 23. The structure of the in-pump detection part 28 is the same as that of the recovery detection part 12, and the description thereof is omitted.

To the concave part 10, an air intake hole 29 through which outside air passes is connected. The air intake hole 29 communicates with the side surface of the outer package part 3 through the sensor module 8 and the outer package part 3. When the transport part 27 transports the sweat 9 to the stimulus-responsive gel 14, the air 22 enters the concave part 10 from the air intake hole 29. Therefore, the atmospheric pressure in the concave part 10 does not decrease, and thus, the transport part 27 can easily transport the sweat 9 to the stimulus-responsive gel 14.

In the back cover 7, a hinge 30 is provided on a side on the −X direction side. The outer package part 3 and the back cover 7 are connected to each other with the hinge 30. The back cover 7 rotates around the hinge 30. On a side on the +X direction side of the back cover 7, a concave part 7b is provided. On the outer package part 3 on the +X direction side of the concave part 7b, an opening and closing tab 31 which can move in the X direction is provided. The opening and closing tab 31 is energized in the −X direction by a spring 31b. On the −X direction side of the opening and closing tab 31, a convex part 31a is provided.

The back cover 7 is closed by being rotated around the hinge 30. At this time, the convex part 31a of the opening and closing tab 31 is inserted into the concave part 7b of the back cover 7. According to this, the opening and closing tab 31 can maintain a state where the back cover 7 is closed.

On the −Z direction side of the sensor module 8 and the pump 17, a circuit unit 32 is provided. The circuit unit 32 includes a circuit board 33, and on the circuit board 33, a semiconductor element 34 constituting an electrical circuit and a rechargeable battery 35 are provided. The rechargeable battery 35 is electrically connected to a power supply connector (not shown) and can be charged through the power supply connector. Other than these, an operation switch 5 is provided on the circuit board 33.

On the −Z direction side of the circuit unit 32, a spacer 36 and the display part 6 are provided in a stacked manner. The spacer 36 is a structural body provided between the circuit unit 32 and the display part 6. A plurality of electrical elements are provided on the surface on the −Z direction side of the circuit unit 32, and therefore, irregularities are formed. The spacer 36 is provided covering the circuit board 33 so as to flatten the surface thereof on the display part 6 side. The spacer 36 is provided with a plurality of holes, and the operation switch 5 passes through the hole.

On the −Z direction side of the display part 6, a glass plate 37 is provided, and the glass plate 37 is fixed to the outer package part 3. The glass plate 37 prevents the penetration of sweat or dust from the surface 3a side of the outer package part 3.

Around the concave part 10, a side wall 8a having a cylindrical shape is provided. The side wall 8a protrudes to the +Z direction side from the back cover 7. The side wall 8a presses the test surface 2a, and therefore, the side wall 8a prevents the sweat 9 in the concave part 10 from flowing along the test surface 2a.

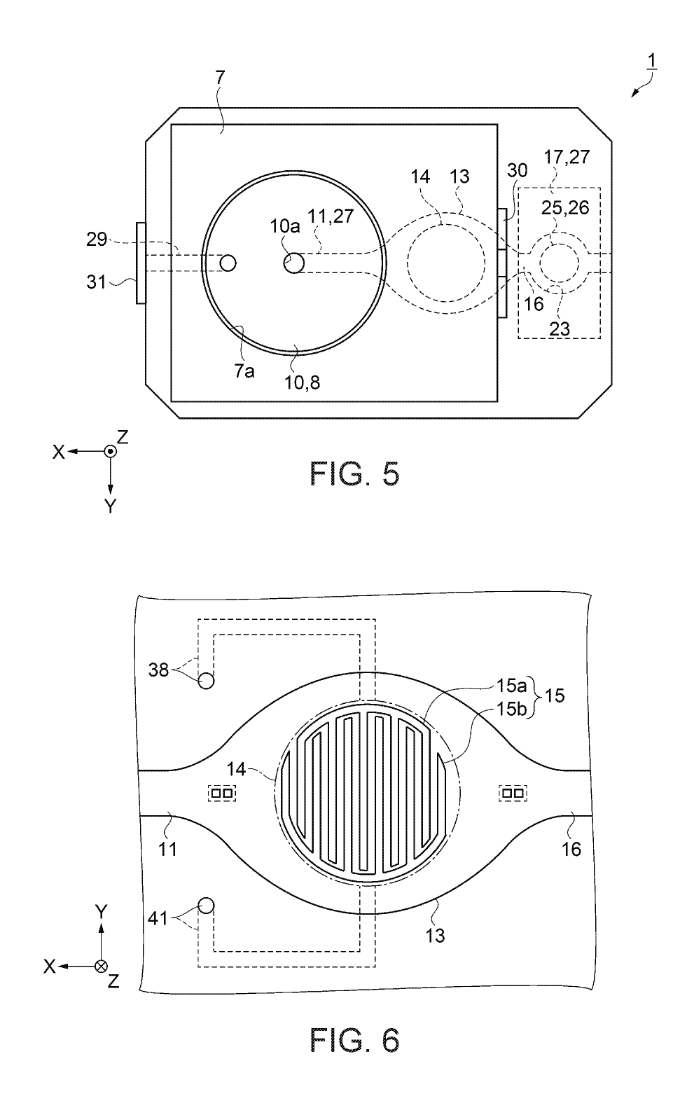

FIG. 5 is a schematic plan view showing the structure of the lactic acid measurement device, and is a view seen from the +Z direction. As shown in FIG. 5, when the lactic acid measurement device 1 is seen from the back surface 3b side, the concave part 10 is exposed through the opening 7a of the back cover 7. In the center of the concave part 10, the flow channel connection part 10a is located. The flow channel connection part 10a, the reaction part upstream flow channel 11, and the reaction part downstream flow channel 16 have substantially the same diameter. The reaction part flow channel 13 has a streamlined shape when seen from the +Z direction side.

In the reaction part flow channel 13, the stimulus-responsive gel 14 is provided. The reaction part flow channel 13 has a streamlined shape. At this time, the sweat 9 flows against a small resistance, and therefore, the sweat 9 can be made to flow by a small pressure difference.

The reaction part downstream flow channel 16 is connected to the pressure chamber 23. The pressure chamber 23 has a circular shape when seen from the +Z direction side, and the piezoelectric element 26 having a circular shape is provided in the center of the pressure chamber 23. The pressure chamber 23 has a larger area than the flow channel connection part 10a and the reaction part upstream flow channel 11, and therefore, even if the distance at which the piezoelectric element 26 contracts in the Z direction is short, the sweat 9 can be reliably made to flow.

FIG. 6 is a schematic plan view showing the structure of the electrical property detection part. As shown in FIG. 6, in the reaction part flow channel 13, the electrical property detection part 15 is provided. The stimulus-responsive gel 14 is provided covering the electrical property detection part 15, however, in the drawing, a state where the stimulus-responsive gel 14 is not provided is shown. The electrical property detection part 15 includes a first electrode 15a and a second electrode 15b. Each of the first electrode 15a and the second electrode 15b has a plurality of portions extending long in the Y direction. The portion extending long in the Y direction of the first electrode 15a and the portion extending long in the Y direction of the second electrode 15b are alternately arranged at predetermined intervals. In this manner, the form in which the first electrode 15a and the second electrode 15b are alternately arranged is referred to as “comb-tooth electrode”.

To the first electrode 15a, a first wiring 38 is connected. To the second electrode 15b, a second wiring 41 is connected. The first wiring 38 and the second wiring 41 are connected to a circuit provided on the circuit board 33. Between the first electrode 15a and the second electrode 15b, the stimulus-responsive gel 14 is provided. When a voltage is applied between the first electrode 15a and the second electrode 15b, an electric current flows through the stimulus-responsive gel 14.

The stimulus-responsive gel 14 reacts with lactic acid contained in the sweat 9 and changes its electrical property. At this time, an electric current flowing through the stimulus-responsive gel 14 changes. The circuit provided on the circuit board 33 applies an AC voltage to the electrical property detection part 15. Then, an impedance between the first electrode 15a and the second electrode 15b is detected. The impedance is one of the electrical properties of the stimulus-responsive gel 14.

The stimulus-responsive gel 14 is provided covering the electrical property detection part 15. The electrical property detection part 15 is disposed such that it does not directly come in contact with the sweat 9. According to this, it is possible to prevent the impedance of the sweat 9 from affecting the detection of the impedance of the stimulus-responsive gel 14.

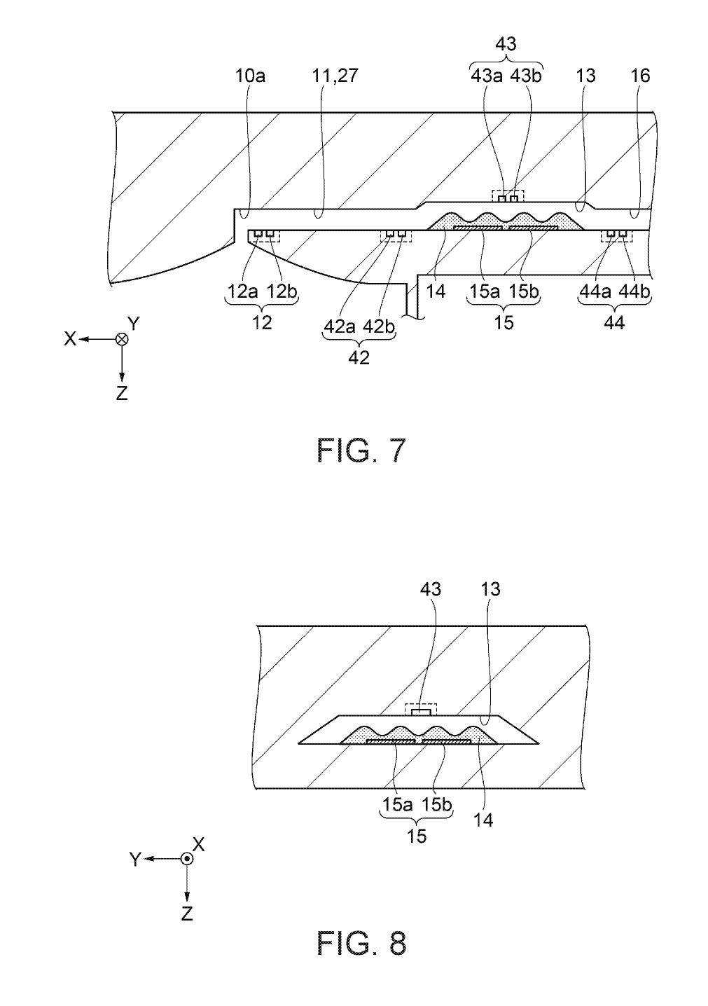

FIG. 7 is a schematic side cross-sectional view of a principal part showing the structure of the flow channel, and is a view seen from the Y direction. As shown in FIG. 7, in the flow channel connection part 10a, the recovery detection part 12 which detects whether or not the sweat 9 is recovered is provided. The recovery detection part 12 includes a first recovery detection electrode 12a and a second recovery detection electrode 12b. The first recovery detection electrode 12a and the second recovery detection electrode 12b are connected to the circuit provided on the circuit board 33 through a wiring (not shown).

When the sweat 9 is present on the recovery detection part 12, the resistance between the first recovery detection electrode 12a and the second recovery detection electrode 12b decreases, so that an electric current easily flows. The circuit provided on the circuit board 33 measures the resistance between the first recovery detection electrode 12a and the second recovery detection electrode 12b, and detects whether or not the sweat 9 has reached the recovery detection part 12.

In this manner, the recovery detection part 12 detects whether or not the sweat 9 is recovered. When the recovery detection part 12 detects that the sweat 9 is not recovered in the flow channel connection part 10a, it is not necessary to operate the transport part 27 and the electrical property detection part 15, and therefore, it is possible to suppress the power consumption of the transport part 27 and the electrical property detection part 15.

On the reaction part flow channel 13 side of the reaction part upstream flow channel 11, a first supply detection part 42 is provided. The first supply detection part 42 is provided near the electrical property detection part 15 and detects whether or not the sweat 9 is supplied to the stimulus-responsive gel 14. The first supply detection part 42 includes a first supply detection electrode 42a and a second supply detection electrode 42b. The first supply detection electrode 42a and the second supply detection electrode 42b are connected to the circuit provided on the circuit board 33 through a wiring (not shown).

In the reaction part flow channel 13, a second supply detection part 43 is provided. The second supply detection part 43 is provided in a place facing the stimulus-responsive gel 14 and detects whether or not the sweat 9 is supplied to the stimulus-responsive gel 14. The second supply detection part 43 includes a third supply detection electrode 43a and a fourth supply detection electrode 43b. The third supply detection electrode 43a and the fourth supply detection electrode 43b are connected to the circuit provided on the circuit board 33 through a wiring (not shown). The first supply detection part 42 and the second supply detection part 43 constitute the supply detection part.

The first supply detection electrode 42a and the second supply detection electrode 42b have the same function as that of the recovery detection part 12. The third supply detection electrode 43a and the fourth supply detection electrode 43b also have the same function as that of the recovery detection part 12. The circuit provided on the circuit board 33 measures the resistance between the first supply detection electrode 42a and the second supply detection electrode 42b, and detects whether or not the sweat 9 has reached the first supply detection part 42. The circuit provided on the circuit board 33 measures the resistance between the third supply detection electrode 43a and the fourth supply detection electrode 43b, and detects whether or not the sweat 9 has reached the second supply detection part 43.

The sweat 9 reaches the first supply detection part 42, and then reaches the second supply detection part 43. The time when the sweat 9 reaches the first supply detection part is immediately before the sweat 9 reaches the stimulus-responsive gel 14. The sweat 9 has reached the stimulus-responsive gel 14 when the sweat 9 reaches the second supply detection part 43. The time when the sweat 9 is supplied to the stimulus-responsive gel 14 is between the time when the sweat 9 reaches the first supply detection part 42 and the time when the sweat 9 reaches the second supply detection part 43.

The first supply detection part 42 and the second supply detection part 43 detect whether or not the sweat 9 is supplied to the stimulus-responsive gel 14. Then, the first supply detection part 42 and the second supply detection part 43 detect the time when the supply of the sweat 9 is started. As the time when the supply of the sweat 9 to the stimulus-responsive gel 14 is started, the time when the sweat 9 reaches the first supply detection part 42 may be adopted, or the time when the sweat 9 reaches the second supply detection part 43 may be adopted. Other than these, as the time when the sweat 9 is supplied to the stimulus-responsive gel 14, a time between the time when the sweat 9 reaches the first supply detection part 42 and the time when the sweat 9 reaches the second supply detection part 43 may be adopted.

When the recovery detection part 12 detects that the sweat 9 is not recovered in the flow channel connection part 10a, it is not necessary that the circuit provided on the circuit board 33 operate the first supply detection part 42 and the second supply detection part 43. According to this, it is possible to suppress the power consumption of the first supply detection part 42 and the second supply detection part 43.

In the reaction part downstream flow channel 16, a passage detection part 44 is provided. The passage detection part 44 detects whether or not a portion of the sweat 9 supplied to the stimulus-responsive gel 14 passes through the stimulus-responsive gel 14. The passage detection part 44 includes a first passage detection electrode 44a and a second passage detection electrode 44b. The first passage detection electrode 44a and the second passage detection electrode 44b are connected to the circuit provided on the circuit board 33 through a wiring (not shown).

When a portion of the sweat 9 passes through the stimulus-responsive gel 14, a portion of the sweat 9 is retained in the stimulus-responsive gel 14. Therefore, by stopping the transport of the sweat 9 by the pump 17 when a portion of the sweat 9 passes through the stimulus-responsive gel 14, a portion of the sweat 9 can be retained in the stimulus-responsive gel 14. Therefore, even if the amount of the sweat 9 is small, the sweat 9 can be reacted with the stimulus-responsive gel 14.

When the stimulus-responsive gel 14 is seen from the Y direction, irregularities are provided on the surface of the stimulus-responsive gel 14. According to this, the surface area of the surface of the stimulus-responsive gel 14 becomes larger than in the case where irregularities are not provided. When the surface area is large, the area where the sweat 9 comes in contact with the stimulus-responsive gel 14 is large, and therefore, the sweat 9 is more likely to react with the stimulus-responsive gel 14. Therefore, the stimulus-responsive gel 14 can be reacted with the sweat 9 more quickly.

FIG. 8 is a schematic side cross-sectional view of a principal part showing the structure of the flow channel, and is a view seen from the X direction. As shown in FIG. 8, also when seen from the X direction, irregularities are provided on the surface of the stimulus-responsive gel 14. According to this, the sweat 9 is more likely to react with the stimulus-responsive gel 14. Therefore, the stimulus-responsive gel 14 can be reacted with the sweat 9 more quickly.

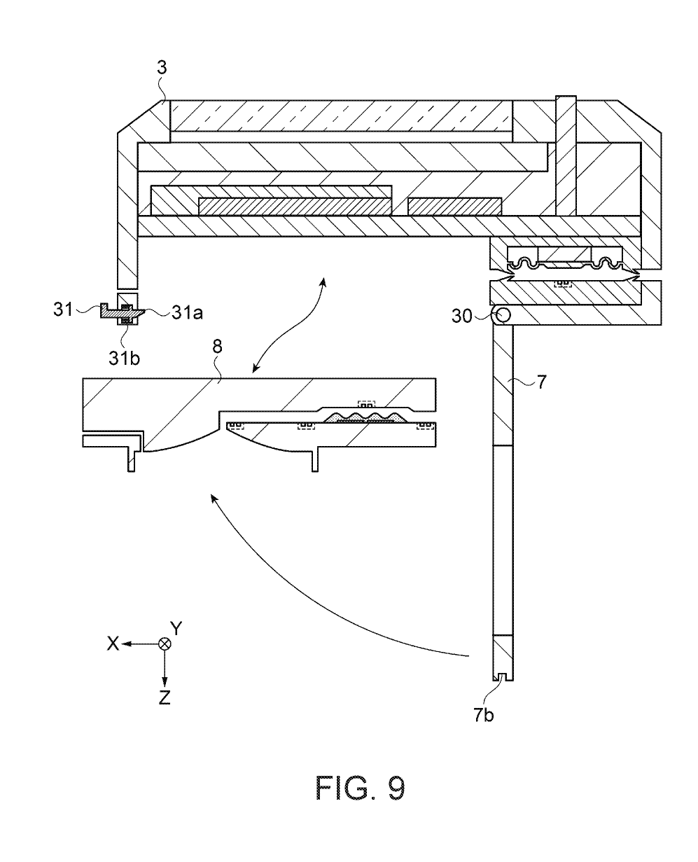

FIG. 9 is a schematic side cross-sectional view for illustrating the structure of the back cover. As shown in FIG. 9, the opening and closing tab 31 is provided on the surface on the +X direction side of the outer package part 3. When the back cover 7 is closed, the convex part 31a of the opening and closing tab 31 is inserted into the concave part 7b so that the opening and closing tab 31 is energized. Then, the back cover 7 is configured such that it is not opened. When an operator pulls out the opening and closing tab 31, the convex part 31a is pulled out from the concave part 7b. Then, the operator rotates the back cover 7 around the hinge 30.

By rotating the back cover 7, the sensor module 8 is exposed. Therefore, the operator can replace the sensor module 8. It is difficult to reuse the sensor module 8 by removing the sweat 9 from the stimulus-responsive gel 14 after the lactic acid measurement device 1 is attached to the test subject 2 and the sweat 9 is reacted with the stimulus-responsive gel 14. Therefore, the operator removes the used sensor module 8 from the lactic acid measurement device 1, and places an unused sensor module 8 in the lactic acid measurement device 1.

The operator closes the back cover 7 after the unused sensor module 8 is placed in the lactic acid measurement device 1. Subsequently, the convex part 31a of the opening and closing tab 31 is inserted into the concave part 7b. By this operation, the sweat 9 is recovered from the test subject 2, and can be reacted with the stimulus-responsive gel 14 using the lactic acid measurement device 1. Then, the concentration of lactic acid contained in the sweat 9 of the test subject 2 can be measured.

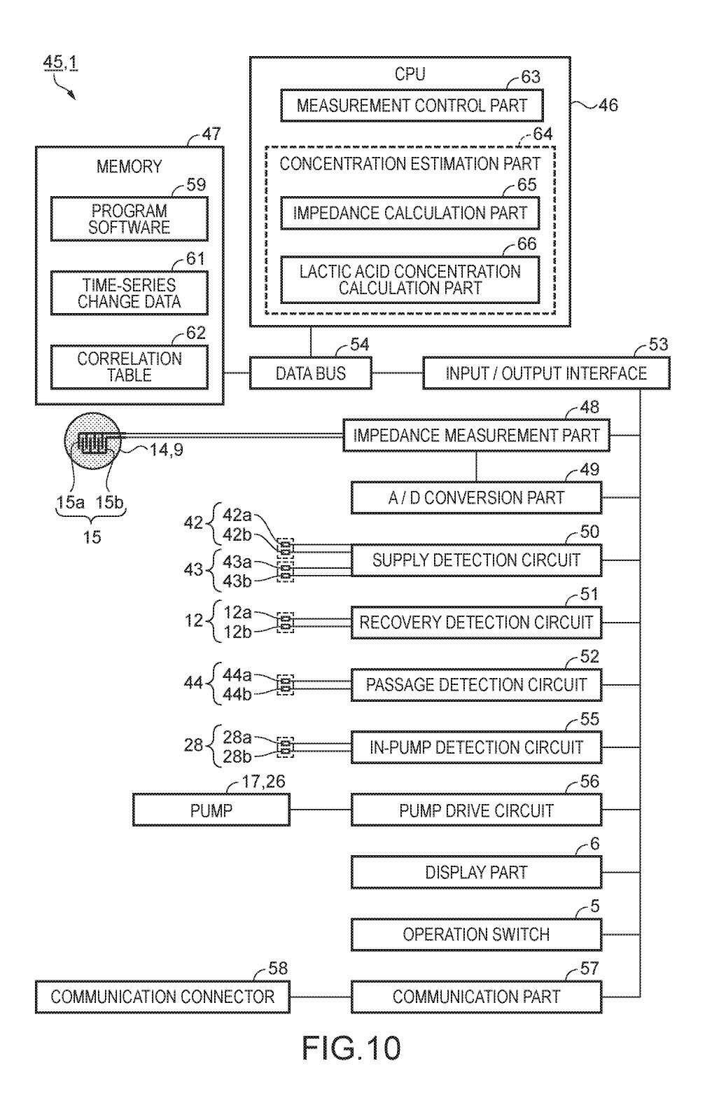

FIG. 10 is a block diagram for the electrical control of the lactic acid measurement device. As shown in FIG. 10, the lactic acid measurement device 1 includes an electrical circuit 45 as a control part which controls the operation of the lactic acid measurement device 1. The electrical circuit 45 is provided on the circuit board 33. The electrical circuit 45 includes a CPU 46 (Central Processing Unit), which performs a variety of calculation processing as a processor, and a memory 47 which stores a variety of information. An impedance measurement part 48, an A/D conversion part 49 (Analog Digital), a supply detection circuit 50, a recovery detection circuit 51, and a passage detection circuit 52 are connected to the CPU 46 through an input/output interface 53 and a data bus 54. Further, an in-pump detection part 55, a pump drive circuit 56, the display part 6, the operation switch 5, and a communication part 57 are connected to the CPU 46 through the input/output interface 53 and the data bus 54.

The impedance measurement part 48 applies an AC voltage to the first electrode 15a and the second electrode 15b provided in the stimulus-responsive gel 14 and detects an electric current flowing between the first electrode 15a and the second electrode 15b. Further, it is a part which calculates an impedance from the AC voltage and the electric current and outputs the calculated impedance. The electrical conductivity of the stimulus-responsive gel 14 changes according to the concentration of lactic acid contained in the stimulus-responsive gel 14. Further, the electrical conductivity and the impedance have a correlation. Therefore, by detecting the impedance of the stimulus-responsive gel 14 by the impedance measurement part 48, the change in the stimulus-responsive gel 14 due to lactic acid can be detected.

A DC current flowing when a constant voltage is applied between the first electrode 15a and the second electrode 15b is very small. Therefore, the impedance measurement part 48 applies a DC voltage between the first electrode 15a and the second electrode 15b, and measures the impedance between the first electrode 15a and the second electrode 15b. That is, the impedance measurement part 48 measures the impedance having a correlation with the electrical conductivity without directly measuring the electrical conductivity. Then, the impedance is utilized in place of the electrical conductivity.

The A/D conversion part 49 is a part which converts the impedance of the stimulus-responsive gel 14 detected by the impedance measurement part 48 to a digital data signal and outputs the signal. The first electrode 15a, the second electrode 15b, the impedance measurement part 48, the A/D conversion part 49, etc. constitute a conversion unit. The A/D conversion part 49 outputs the digital data signal converted at predetermined time intervals. Therefore, the elapsed time shown by the digital data signal can be found from the number of continuous digital data signals.

The supply detection circuit 50 is a circuit which drives the first supply detection part 42 and the second supply detection part 43. The supply detection circuit 50 applies a voltage between the first supply detection electrode 42a and the second supply detection electrode 42b, and detects an electric current flowing between the first supply detection electrode 42a and the second supply detection electrode 42b. When the sweat 9 reaches the first supply detection part 42 and is adhered thereto, an electric current flowing between the first supply detection electrode 42a and the second supply detection electrode 42b increases. Then, the supply detection circuit 50 outputs whether or not the sweat 9 has reached the first supply detection part 42 to the CPU 46.

Further, the supply detection circuit 50 applies a voltage between the third supply detection electrode 43a and the fourth supply detection electrode 43b, and detects an electric current flowing between the third supply detection electrode 43a and the fourth supply detection electrode 43b. When the sweat 9 reaches the second supply detection part 43 and is adhered thereto, an electric current flowing between the third supply detection electrode 43a and the fourth supply detection electrode 43b increases. Then, the supply detection circuit 50 outputs whether or not the sweat 9 has reached the second supply detection part 43 to the CPU 46.

The recovery detection circuit 51 is a circuit which drives the recovery detection part 12. The recovery detection circuit 51 applies a voltage between the first recovery detection electrode 12a and the second recovery detection electrode 12b, and detects an electric current flowing between the first recovery detection electrode 12a and the second recovery detection electrode 12b. When the sweat 9 reaches the recovery detection part 12 and is adhered thereto, an electric current flowing between the first recovery detection electrode 12a and the second recovery detection electrode 12b increases. Then, the recovery detection circuit 51 outputs whether or not the sweat 9 has reached the recovery detection part 12 to the CPU 46.

The passage detection circuit 52 is a circuit which drives the passage detection part 44. The passage detection circuit 52 applies a voltage between the first passage detection electrode 44a and the second passage detection electrode 44b, and detects an electric current flowing between the first passage detection electrode 44a and the second passage detection electrode 44b. When the sweat 9 reaches the passage detection part 44 and is adhered thereto, an electric current flowing between the first passage detection electrode 44a and the second passage detection electrode 44b increases. Then, the passage detection circuit 52 outputs whether or not the sweat 9 has reached the passage detection part 44 to the CPU 46.

The in-pump detection circuit 55 is a circuit which drives the in-pump detection part 28. The in-pump detection part 28 applies a voltage between a first in-pump detection electrode 28a and a second in-pump detection electrode 28b, and detects an electric current flowing between the first in-pump detection electrode 28a and the second in-pump detection electrode 28b. When the sweat 9 reaches the in-pump detection part 28 and is adhered thereto, an electric current flowing between the first in-pump detection electrode 28a and the second in-pump detection electrode 28b increases. Then, the in-pump detection circuit 55 outputs whether or not the sweat 9 has reached the in-pump detection part 28 to the CPU 46.

The pump drive circuit 56 is a circuit which drives the pump 17. In the pump 17, the piezoelectric element 26 is provided. The pump drive circuit 56 applies an AC voltage to the piezoelectric element 26 to contract the piezoelectric element 26. Then, the CPU 46 receives the output of the in-pump detection circuit 55. When the pressure chamber 23 is filled with the air 22, an instruction that the amplitude of the piezoelectric element 26 is increased as compared with the case where the pressure chamber 23 is filled with the sweat 9 is output to the pump drive circuit 56. The air 22 has a higher compressibility than the sweat 9, and therefore, the pump 17 can efficiently transport the sweat 9.

The display part 6 is a part which displays the measurement result of the concentration of lactic acid. The display part 6 displays the impedance of the stimulus-responsive gel 14, the measurement result of the concentration of lactic acid contained in the sweat 9, the measurement conditions, etc. In the display part 6, a liquid crystal display device, an organic electroluminescence display, a plasma display, and other than these, a surface-conduction electron-emitter display can be used.

The operation switch 5 is a switch which operates the lactic acid measurement device 1. An operator performs the input of a variety of instructions such as an instruction of start of measurement of lactic acid or measurement conditions by operating the operation switch 5.

The communication part 57 is a part which communicates with an external device. In the communication part 57, a communication connector 58 is provided, and an external device is connected to the communication connector 58 through a wiring. The communication part 57 sends the data of the measured concentration of lactic acid to the external device through the communication connector 58. Further, the measurement conditions are input from the external device.

The memory 47 is a concept including a semiconductor memory such as a RAM and a ROM, and an external storage device such as a hard disk and a DVD-ROM. Functionally, a storage area for storing program software 59 describing a procedure for controlling the operation of the lactic acid measurement device 1 is set. Further, a storage area for storing time-series change data 61 which shows a shift in the impedance between the first electrode 15a and the second electrode 15b is set. Other than these, a storage area for storing data of a correlation table 62 which shows a relationship between the impedance and the concentration of lactic acid is set. Further, a storage area which functions as a work area, a temporary file, or the like for the CPU 46, and various other storage areas are set.

The CPU 46 controls the measurement of the concentration of lactic acid according to the program software stored in the memory 47. The CPU 46 has a measurement control part 63 as a specific function implementation part. The measurement control part 63 drives the pump drive circuit 56, the impedance measurement part 48, and the like according to a measurement procedure. The measurement control part 63 drives the pump drive circuit 56, and supplies the sweat 9 to the stimulus-responsive gel 14. Then, the measurement control part 63 drives the impedance measurement part 48 and the like and controls a voltage value to be output to the first electrode 15a and the second electrode 15b.

The CPU 46 also has a concentration estimation part 64. The concentration estimation part 64 has an impedance calculation part 65 and a lactic acid concentration calculation part 66. The impedance calculation part 65 inputs the measurement data of the impedance of the stimulus-responsive gel 14 from the A/D conversion part 49. Then, the impedance calculation part 65 estimates the saturated impedance of the stimulus-responsive gel 14 from the time-series change in the measurement data of the impedance. The lactic acid concentration calculation part 66 inputs the estimated value of the saturated impedance estimated by the impedance calculation part 65. Then, the lactic acid concentration calculation part 66 calculates the concentration of lactic acid with reference to the estimated value of the saturated impedance and the correlation table 62. That is, the concentration estimation part 64 estimates the concentration of lactic acid contained in the sweat 9 from the time-series change in the impedance of the stimulus-responsive gel 14.

Other than these, the CPU 46 controls the output of the concentration of lactic acid calculated by the lactic acid concentration calculation part 66 to the display part 6. Further, the CPU 46 controls the operation of the lactic acid measurement device 1 according to the signal input from the operation switch 5. Further, the CPU 46 outputs the data signal of the concentration of lactic acid to the external device by driving the communication part 57, and inputs the measurement conditions from the external device.

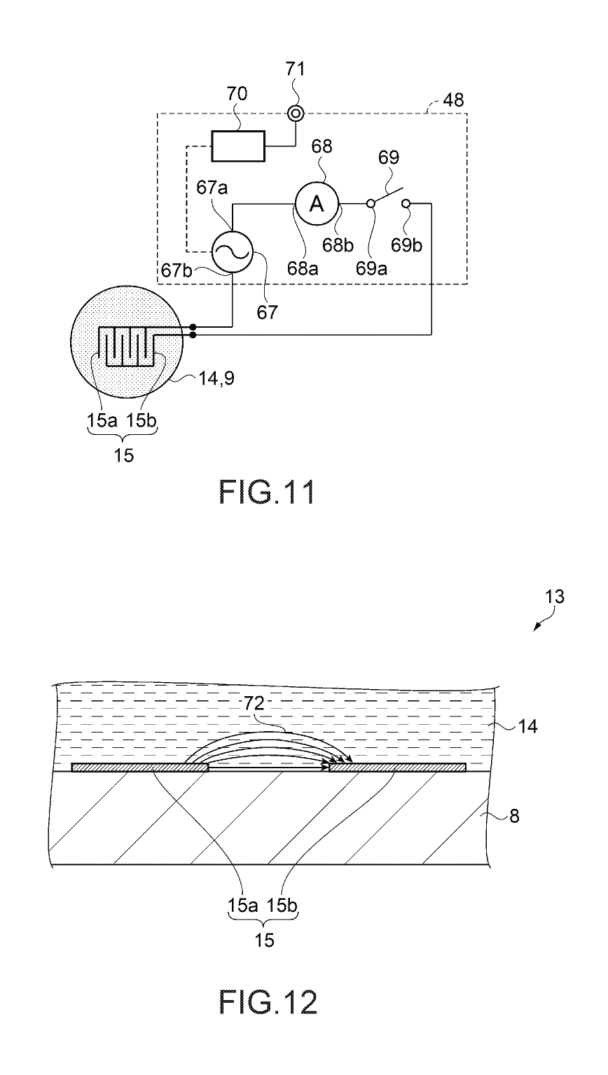

FIG. 11 is a view for illustrating the structure of the impedance measurement part. As shown in FIG. 11, the impedance measurement part 48 includes a power supply part 67, an ammeter 68, and a switch 69. The power supply part 67 is an AC power supply having two terminals: a first terminal 67a; and a second terminal 67b, and the frequency of the AC voltage is 10 kHz or more and 1 MHz or less. The power supply part 67 is connected to the CPU 46, and the voltage and frequency are controlled by the CPU 46. Also, the ammeter 68 has two terminals: a first terminal 68a; and a second terminal 68b, and the first terminal 67a of the power supply part 67 is connected to the first terminal 68a of the ammeter 68. The second terminal 67b of the power supply part 67 is connected to the first electrode 15a.

The switch 69 has two terminals: a first terminal 69a; and a second terminal 69b. The switch 69 can select whether the first terminal 69a and the second terminal 69b are short-circuited or open-circuited. The second terminal 69b is connected to the second electrode 15b.

When the switch 69 short-circuits the first terminal 69a and the second terminal 69b, the power supply part 67 supplies an AC voltage between the first electrode 15a and the second electrode 15b. Then, the ammeter 68 detects an electric current flowing between the first electrode 15a and the second electrode 15b. The switch 69 is connected to the CPU 46, and performs switching based on the instruction signal of the CPU 46.

In the impedance measurement part 48, a divider circuit 70 and an output terminal 71 are provided, and a voltage signal showing the voltage of the power supply part 67 is output to the divider circuit 70. Further, also an electric current signal showing the electric current detected by the ammeter 68 is output to the divider circuit 70. The divider circuit 70 calculates the impedance by dividing the voltage signal by the electric current signal. Then, the impedance signal showing the impedance is output to the output terminal 71. In this manner, the impedance measurement part 48 measures the impedance between the first electrode 15a and the second electrode 15b, and outputs the impedance.

When a voltage is applied between the first electrode 15a and the second electrode 15b, an electrical double layer due to water molecules is formed on the surface of each electrode. When a DC voltage is applied between the respective electrodes, the electrical double layer acts as an electrical capacitance, and therefore, an electric current corresponding to an electrical conductivity cannot be accurately measured. In this embodiment, the power supply part 67 supplies an AC voltage. Therefore, since an AC current flows between the respective electrodes, the effect of the electrical double layer on the measurement of the impedance can be reduced.

In the impedance measurement part 48, by switching the switch 69, the power supply part 67 and the ammeter 68 control whether or not the electrical property detection part 15 detects the impedance. In order to measure the very small resistance value of the stimulus-responsive gel 14, it is preferred to reduce the resistance values of the wirings in the impedance measurement part 48 as much as possible. Further, it is preferred to also reduce the resistance values of the wirings between the impedance measurement part 48 and each of the first electrode 15a and the second electrode 15b as much as possible.

FIG. 12 is a schematic view for illustrating an electric field in the electrical property detection part. As shown in FIG. 12, in the electrical property detection part 15, the first electrode 15a and the second electrode 15b are placed side by side in the reaction part flow channel 13. The first electrode 15a and the second electrode 15b are covered with the stimulus-responsive gel 14. When the switch 69 short-circuits the first terminal 69a and the second terminal 69b, an electric current 72 flows between the first electrode 15a and the second electrode 15b. The power supply part 67 is an AC power supply, and therefore, the flowing direction of the electric current 72 is reversed at a predetermined frequency.

An electric field generated between the first electrode 15a and the second electrode 15b is concentrated between the first electrode 15a and the second electrode 15b, and is not generated in a place at a distance from the electrical property detection part 15. Therefore, it is not necessary to increase the thickness of the stimulus-responsive gel 14. However, it is preferred that the thickness of the stimulus-responsive gel 14 is set larger than the thickness of each of the first electrode 15a and the second electrode 15b so as to cover the first electrode 15a and the second electrode 15b between the electrodes. When the thickness of the stimulus-responsive gel 14 is smaller than the thickness of the first electrode 15a, an electric current flowing between the first electrode 15a and the second electrode 15b includes an electric current passing through the stimulus-responsive gel 14 and an electric current passing through the sweat 9. Therefore, it is difficult to detect the impedance of the stimulus-responsive gel 14. In this embodiment, for example, the thickness of each of the first electrode 15a and the second electrode 15b is set to 50 nm or more and 100 nm or less, and the thickness of the stimulus-responsive gel 14 is set to 100 nm or more and 1 mm or less.

The first electrode 15a and the second electrode 15b in the stimulus-responsive gel 14 are connected to the impedance measurement part 48. The CPU 46 drives the impedance measurement part 48 to apply a voltage between the first electrode 15a and the second electrode 15b. Then, the impedance measurement part 48 detects the impedance from the electric current flowing between the first electrode 15a and the second electrode 15b and outputs the value to the A/D conversion part 49. The A/D conversion part 49 converts the value of the electric current to a data signal which is digital data. Then, the A/D conversion part 49 outputs the data signal to the CPU 46 and the memory 47. The CPU 46 inputs the data signal from the A/D conversion part 49 and estimates the saturated impedance. Subsequently, the correlation table 62 is input from the memory 47. In the correlation table 62, the data of the concentration of lactic acid corresponding to the saturated impedance is described. Then, in the CPU 46, the lactic acid concentration calculation part 66 calculates the concentration of lactic acid using the saturated impedance and the correlation table 62.

The CPU 46 outputs the data of the measurement results of the concentration of lactic acid to the display part 6, and the display part 6 displays the measurement results of the concentration of lactic acid. The test subject 2 looks at the display part 6 and confirms the concentration of lactic acid in the sweat. Further, the CPU 46 outputs the data of a graph showing the shift in the measurement result of the concentration of lactic acid to the display part 6, and the display part 6 displays the graph showing the shift in the measurement result of the concentration of lactic acid. The test subject 2 looks at the display part 6 and confirms the shift in the concentration of lactic acid in the sweat.

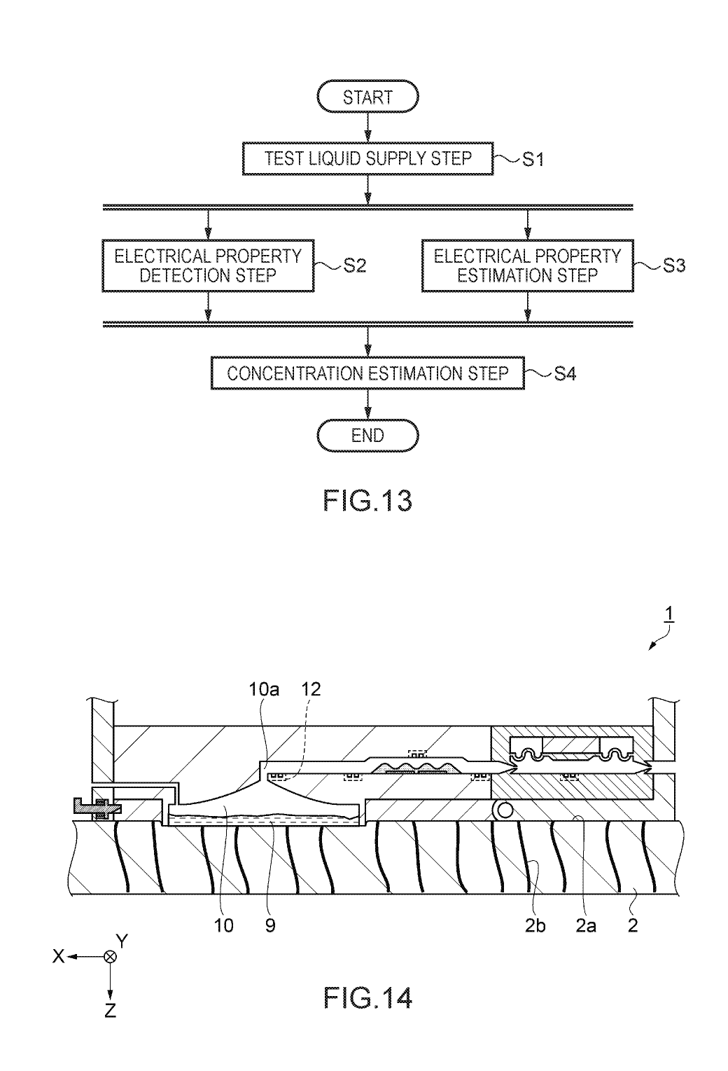

Next, the component concentration estimation method using the above-mentioned lactic acid measurement device 1 will be described with reference to FIGS. 13 to 19. FIG. 13 is a flowchart of the component concentration estimation method. FIGS. 14 to 19 are each a schematic view for illustrating the component concentration estimation method. In the flowchart shown in FIG. 13, Step S1 corresponds to a test liquid supply step. This step is a step of supplying the sweat 9 retained in the concave part 10 to the stimulus-responsive gel 14 in the reaction part flow channel 13. That is, the sweat 9 is supplied to the stimulus-responsive gel 14 in the form of a gel which reacts with lactic acid contained in the sweat 9 and changes its impedance.

Subsequently, the process proceeds to Step S2 and Step S3. Step S2 and Step S3 are performed at the same time. Step S2 is an electrical property detection step. This step is a step of detecting the electrical property of the stimulus-responsive gel 14. More specifically, the impedance of the stimulus-responsive gel 14 is measured, and the measurement data is stored as the time-series change data 61 in the memory 47. Step S2 is continued until Step S3 is completed. When Step S3 is completed, also Step S2 is completed. Subsequently, the process proceeds to Step S4.

Step S3 is an electrical property estimation step. This step is a step of estimating the saturated impedance when the impedance of the stimulus-responsive gel 14 is converged and stabilized from the time-series change in the impedance which is the electrical property of the stimulus-responsive gel 14. The term “converged and stabilized” is also referred to as “saturated”. Subsequently, the process proceeds to Step S4. Step S4 is a concentration estimation step. This step is a step of estimating the concentration of lactic acid contained in the sweat 9 from the saturated impedance estimated in Step S3. By combining Step S3 and Step 4, these steps become a step of estimating the concentration of lactic acid contained in the sweat 9 from the time-series change in the impedance which is the electrical property of the stimulus-responsive gel 14. By the above-mentioned steps, the step of estimating the concentration of the component is completed.

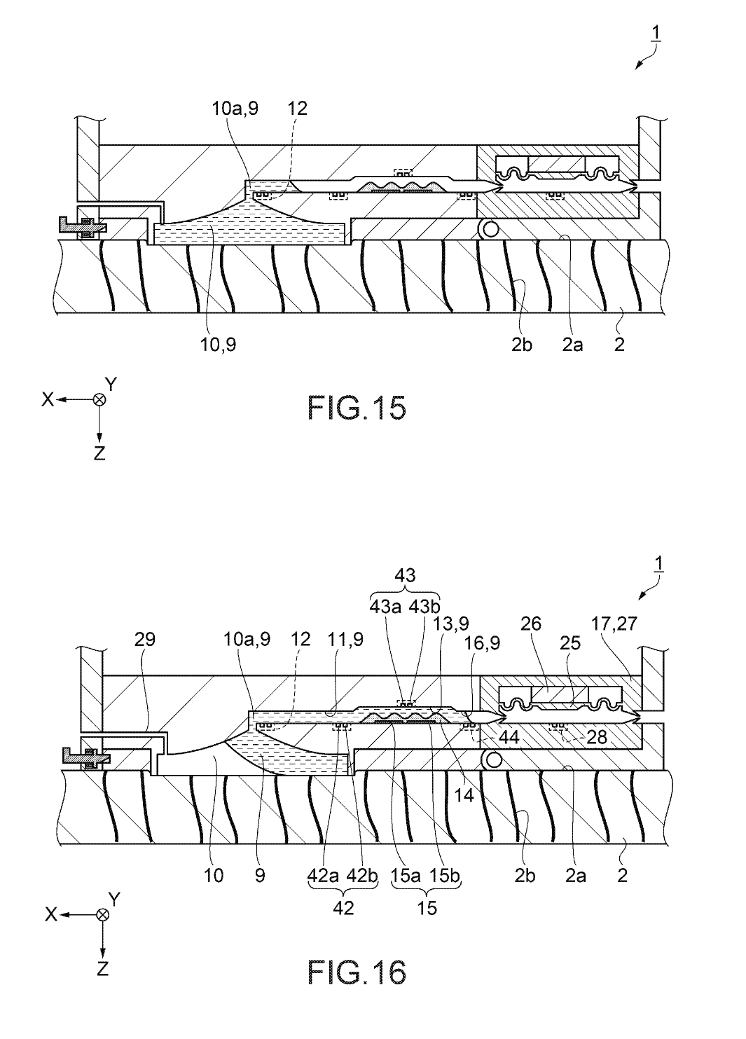

Next, the component concentration estimation method will be described in detail while being made to correspond to the steps shown in FIG. 13 with reference to FIGS. 14 to 19. FIGS. 14 and 15 are views corresponding to the test liquid supply step of Step S1. As shown in FIG. 14, in Step S1, the operator attaches the lactic acid measurement device 1 to the test surface 2a of the test subject 2.

There is a sweat gland 2b in the skin of the test subject 2. When the body temperature of the test subject 2 increases, the sweat 9 is supplied to the test surface 2a from the sweat gland 2b. A portion of the sweat 9 is retained in the concave part 10. However, when the amount of the sweat 9 in the concave part 10 is small, the sweat 9 does not reach the flow channel connection part 10a. At this time, the electrical resistance between the first recovery detection electrode 12a and the second recovery detection electrode 12b is high, and therefore, an electric current does not flow. The recovery detection circuit 51 outputs a signal which indicates that an electric current flowing in the recovery detection part 12 is small to the measurement control part 63.

The measurement control part 63 determines that the sweat 9 does not reach the flow channel connection part 10a, and maintains the electrical property detection part 15, the pump 17, the supply detection circuit 50, and the passage detection circuit 52 in a stopped state. In this manner, when the recovery detection circuit 51 detects that the sweat 9 is not recovered in the flow channel connection part 10a, it is not necessary to operate the pump 17, the supply detection circuit 50, and the impedance measurement part 48, and therefore, it is possible to suppress the power consumption of the pump 17, the supply detection circuit 50, and the impedance measurement part 48.

As shown in FIG. 15, in the concave part 10, the amount of the sweat 9 increases and the sweat 9 reaches the flow channel connection part 10a. At this time, the electrical resistance between the first recovery detection electrode 12a and the second recovery detection electrode 12b decreases, and therefore, an electric current flows between the electrodes. The recovery detection circuit 51 outputs a signal which indicates that an electric current flowing in the recovery detection part 12 has increased to the measurement control part 63.

The measurement control part 63 determines that the sweat 9 has reached the flow channel connection part 10a, and operates the electrical property detection part 15, the pump 17, the supply detection circuit 50, and the passage detection circuit 52. In this manner, when the recovery detection circuit 51 detects that the sweat 9 is recovered in the flow channel connection part 10a, the pump 17, the supply detection circuit 50, and the impedance measurement part 48 are operated. When the sweat 9 is recovered, the pump 17, the supply detection circuit 50, and the impedance measurement part 48 are operated in this manner, and therefore, it is possible to suppress the power consumption of the pump 17, the supply detection circuit 50, and the impedance measurement part 48.

FIG. 16 is a view corresponding to Step S1 and the electrical property detection step of Step S2. As shown in FIG. 16, the measurement control part 63 causes the pump drive circuit 56 to drive the pump 17. As a result, the sweat 9 retained in the concave part 10 reaches the reaction part downstream flow channel 16 through the flow channel connection part 10a, the reaction part upstream flow channel 11, and the reaction part flow channel 13. In the concave part 10, the air intake hole 29 for supplying the air 22 is provided, and therefore, the pump 17 can easily make the sweat 9 to flow. The passage detection circuit 52 detects whether or not an electric current flows through the passage detection part 44. Then, when an electric current flows through the passage detection part 44, the passage detection circuit 52 outputs a signal which indicates that the sweat 9 has reached the passage detection part 44 to the measurement control part 63.

The measurement control part 63 inputs a signal which indicates that the sweat 9 has reached the passage detection part 44. Then, the measurement control part 63 causes the pump drive circuit 56 to stop the driving of the pump 17. By doing this, the sweat 9 can be retained in the reaction part flow channel 13 without passing through the reaction part flow channel 13. In this manner, the transport part 27 supplies the sweat 9 to the stimulus-responsive gel 14 in the form of a gel which reacts with lactic acid contained in the sweat 9 and changes its impedance.

The first supply detection part 42 and the second supply detection part 43 detect the time when the sweat 9 reaches the parts. The sweat 9 flows through the reaction part upstream flow channel 11 and reaches the first supply detection part 42. In the first supply detection part 42, an electric current flowing between the first supply detection electrode 42a and the second supply detection electrode 42b increases. Then, the supply detection circuit 50 outputs a signal which indicates that the sweat 9 has reached the first supply detection part 42 to the impedance calculation part 65.

Subsequently, the sweat 9 enters the reaction part flow channel 13, flows through the reaction part flow channel 13, and reaches the second supply detection part 43. In the second supply detection part 43, an electric current flowing between the third supply detection electrode 43a and the fourth supply detection electrode 43b increases. Then, the supply detection circuit 50 outputs a signal which indicates that the sweat 9 has reached the second supply detection part 43 to the impedance calculation part 65.

When the pump 17 is driven, the electrical property detection step of Step S2 is started. Then, the impedance measurement part 48 measures the impedance between the first electrode 15a and the second electrode 15b. The A/D conversion part 49 converts the measured impedance value to digital data. The A/D conversion part 49 outputs the impedance data to the memory 47. In the memory 47, the impedance data is stored as the time-series change data 61. In this manner, the impedance measurement part 48 detects the impedance of the stimulus-responsive gel 14.

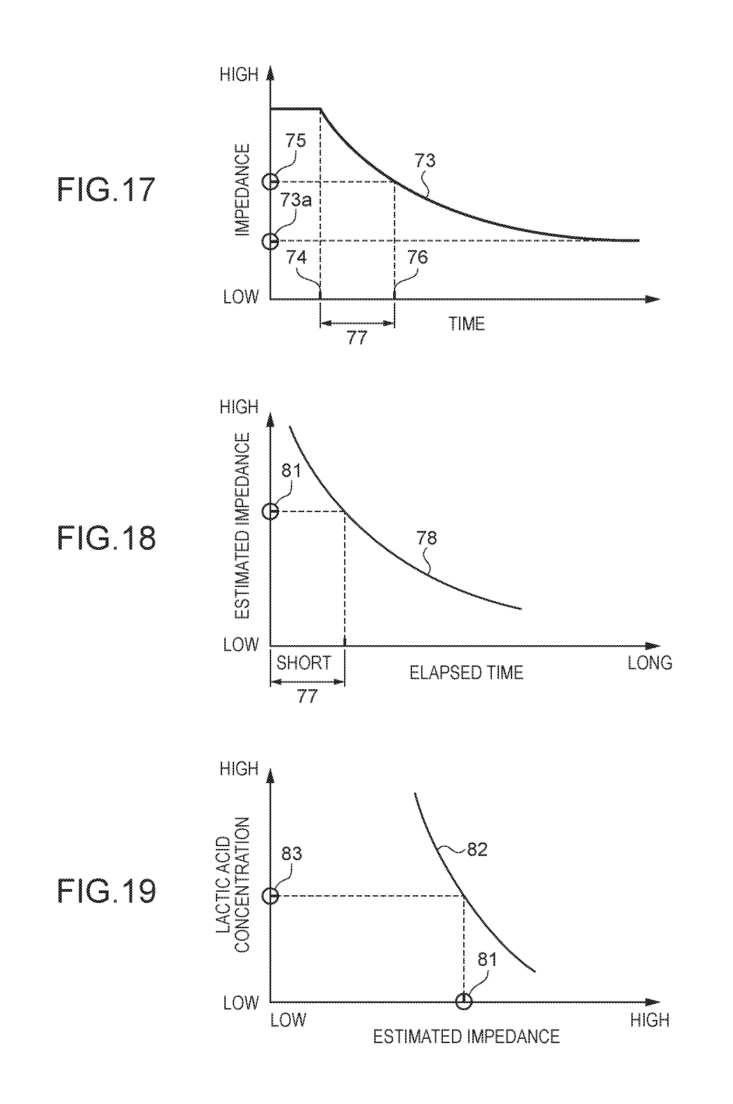

FIG. 17 is a view corresponding to Step S2 and the electrical property estimation step of Step S3. In FIG. 17, the vertical axis represents the impedance between the first electrode 15a and the second electrode 15b, and the impedance is higher on the upper side than on the lower side in the drawing. The horizontal axis represents the elapsed time, and the time shifts from the left side to the right side in the drawing.

A shifting line 73 shows the shift in the impedance between the first electrode 15a and the second electrode 15b. The shifting line 73 is obtained by plotting the impedance value output from the A/D conversion part 49 in Step S2. The shifting line 73 is a line obtained by plotting the data stored as the time-series change data 61 in the memory 47. As shown by the shifting line 73, as the time elapses, the impedance decreases. The sweat 9 permeates the stimulus-responsive gel 14, and the stimulus-responsive gel 14 swells. Therefore, the impedance of the stimulus-responsive gel 14 decreases.

In the horizontal axis, the time when the sweat 9 starts to permeate the stimulus-responsive gel 14 is defined as “first time point 74”. The first time point 74 is set using the time when the sweat 9 has reached the first supply detection part 42 and the second supply detection part 43.

In Step S3, the impedance calculation part 65 compares the impedance input from the A/D conversion part 49 with a determination value 75. The determination value 75 is a value set by previously performing an experiment. The time when the impedance in the shifting line 73 and the determination value 75 coincide with each other is defined as “second time point 76”. Then, the elapsed time between the first time point 74 and the second time point 76 is defined as “measurement elapsed time 77”. The measurement elapsed time 77 is a time required for the impedance of the stimulus-responsive gel 14 to reach the determination value 75. The shifting line 73 is converged and stabilized as the time elapses. This converged and stabilized impedance is defined as “saturated impedance 73a”.

FIG. 18 is a view corresponding to Step S3. In FIG. 18, the vertical axis represents the estimated impedance of the stimulus-responsive gel, and the impedance is higher on the upper side than on the lower side in the drawing. This estimated impedance is an impedance obtained by estimating the saturated impedance 73a. That is, the estimated impedance is not an impedance obtained by actually measuring the saturated impedance 73a, but is an impedance obtained by estimating the saturated impedance 73a from a portion of the shifting line 73. The horizontal axis represents the elapsed time between the first time point 74 and the second time point 76, and the time is longer on the right side than on the left side in the drawing.

A correlation line 78 is a line which indicates a relationship between the elapsed time and the estimated impedance. The correlation line 78 indicates data stored as the correlation table 62 in the memory 47. The correlation line 78 is obtained by previously performing an experiment. The estimated impedance is an impedance obtained by estimating the saturated impedance 73a from the elapsed time between the first time point 74 and the second time point 76.

It is indicated that the shifting line 73 rises steeply when the measurement elapsed time 77 is short. At this time, the saturated impedance 73a becomes high. On the other hand, it is indicated that the shifting line 73 rises gradually when the measurement elapsed time 77 is long. At this time, the saturated impedance 73a becomes low. Therefore, in the correlation line 78, when the elapsed time is short, the estimated impedance becomes high, and when the elapsed time is long, the estimated impedance becomes low. Then, the impedance calculation part 65 calculates the estimated impedance 81 corresponding to the measurement elapsed time 77 using the correlation line 78.

FIG. 19 is a view corresponding to the concentration estimation step of Step S4. In FIG. 19, the vertical axis represents the concentration of lactic acid in the sweat, and the concentration of lactic acid is higher on the upper side than on the lower side in the drawing. The horizontal axis represents the estimated impedance, and the impedance is higher on the right side than on the left side in the drawing. A lactic acid concentration correlation line 82 is a line which indicates a relationship between the estimated impedance and the concentration of lactic acid in the sweat. As shown by the lactic acid concentration correlation line 82, the estimated impedance and the concentration of lactic acid have the following relationship: when the estimated impedance is high, the concentration of lactic acid in the sweat is low, and when the estimated impedance is low, the concentration of lactic acid in the sweat is high.

The lactic acid concentration calculation part 66 calculates a lactic acid concentration 83 corresponding to the estimated impedance 81 using the lactic acid concentration correlation line 82. In this manner, the concentration estimation part 64 estimates the concentration of lactic acid contained in the sweat 9 from the time-series change in the impedance. When the concentration of lactic acid contained in the sweat 9 is high, the reaction proceeds more quickly than when the concentration thereof is low, and therefore, the impedance changes more quickly. That is, the speed at which the impedance changes and the concentration of lactic acid contained in the sweat 9 have a predetermined correlation. The concentration estimation part 64 detects the speed at which the impedance changes from the time-series change in the impedance, and estimates the concentration of lactic acid contained in the sweat 9 from the speed at which the impedance changes. At this time, before the stimulus-responsive gel 14 completely reacts with the sweat 9, the concentration estimation part 64 estimates the concentration of lactic acid contained in the sweat 9. Therefore, the concentration of a lactic acid component contained in the sweat 9 can be estimated in a shorter time than when the stimulus-responsive gel 14 completely reacts with the sweat 9.

The first supply detection part 42 and the second supply detection part 43 detect that the supply of the sweat 9 is started. Then, the concentration estimation part 64 estimates the concentration of lactic acid using the time-series change in the impedance from when the stimulus-responsive gel 14 starts the reaction. The concentration estimation part 64 does not refer to the time-series change before the supply of the sweat 9 is started, and therefore, the time-series change in the electrical property due to the reaction of lactic acid contained in the sweat 9 can be accurately detected.

As described above, according to this embodiment, the following effects are obtained.

(1) According to this embodiment, the lactic acid measurement device 1 includes the stimulus-responsive gel 14, the electrical property detection part 15, and the concentration estimation part 64. The stimulus-responsive gel 14 is in the form of a gel and absorbs the sweat 9. Then, the stimulus-responsive gel 14 reacts with lactic acid contained in the sweat 9. The stimulus-responsive gel 14 reacts with lactic acid and changes its impedance. The electrical property detection part 15 detects the impedance of the stimulus-responsive gel 14. By detecting the impedance, the degree at which the stimulus-responsive gel 14 reacts with lactic acid can be detected.

When the concentration of lactic acid contained in the sweat 9 is high, the reaction proceeds more quickly than when the concentration thereof is low, and therefore, the impedance changes more quickly. That is, the speed at which the impedance changes and the concentration of lactic acid contained in the sweat 9 have a predetermined correlation. The concentration estimation part 64 detects the speed at which the impedance changes from the time-series change in the impedance and estimates the concentration of lactic acid contained in the sweat 9 from the speed at which the impedance changes. At this time, the concentration estimation part 64 estimates the concentration of lactic acid contained in the sweat 9 before the stimulus-responsive gel 14 completely reacts with the sweat 9. Therefore, the concentration of lactic acid contained in the sweat 9 can be estimated in a shorter time than when the stimulus-responsive gel 14 completely reacts with the sweat 9.

(2) According to this embodiment, the lactic acid measurement device 1 includes the first supply detection part 42 and the second supply detection part 43, and the first supply detection part 42 and the second supply detection part 43 detect whether or not the sweat 9 is supplied to the stimulus-responsive gel 14. Then, the first supply detection part 42 and the second supply detection part 43 detect that the supply of the sweat 9 is started. The concentration estimation part 64 estimates the concentration of lactic acid in the sweat 9 using the time-series change in the impedance from when the reaction of the stimulus-responsive gel 14 is started. The concentration estimation part 64 does not refer to the time-series change before the supply of the sweat 9 is started, and therefore, the time-series change in the impedance due to the reaction of lactic acid contained in the sweat 9 can be accurately detected.

(3) According to this embodiment, irregularities are provided on the surface of the stimulus-responsive gel 14. According to this, the surface area of the surface of the stimulus-responsive gel 14 becomes larger than in the case where irregularities are not provided. When the surface area is large, the area where the sweat 9 comes in contact with the stimulus-responsive gel 14 is large, and therefore, the sweat 9 is more likely to react with the stimulus-responsive gel 14. Accordingly, the stimulus-responsive gel 14 reacts with the sweat 9 more quickly, and thus, the concentration estimation part 64 can detect the time-series change in the impedance in a short time.

(4) According to this embodiment, the lactic acid measurement device 1 includes the concave part 10, the flow channel connection part 10a, and the transport part 27. The concave part 10 and the flow channel connection part 10a recover the sweat 9. Then, the transport part 27 transports the sweat 9 to the stimulus-responsive gel 14 from the concave part 10 and the flow channel connection part 10a. In the flow channel connection part 10a, the recovery detection part 12 is provided, and the recovery detection part 12 detects whether or not the sweat 9 is recovered. When the recovery detection part 12 detects that the sweat 9 is not recovered in the flow channel connection part 10a, it is not necessary to operate the transport part 27, the first supply detection part 42, the second supply detection part 43, and the electrical property detection part 15, and therefore, it is possible to suppress the power consumption of the transport part 27, the first supply detection part 42, the second supply detection part 43, and the electrical property detection part 15.

(5) According to this embodiment, the stimulus-responsive gel 14 includes the passage detection part 44, and the passage detection part 44 detects whether or not a portion of the sweat 9 passes through the stimulus-responsive gel 14. When a portion of the sweat 9 passes through the stimulus-responsive gel 14, a portion of the sweat 9 is retained in the stimulus-responsive gel 14. Therefore, by stopping the transport of the sweat 9 by the transport part 27 when a portion of the sweat 9 passes through the stimulus-responsive gel 14, a portion of the sweat 9 can be retained in the stimulus-responsive gel 14. Accordingly, even if the amount of the sweat 9 is small, the sweat 9 can be reacted with the stimulus-responsive gel 14.

(6) According to this embodiment, the lactic acid measurement device 1 includes the reaction part flow channel 13 through which the sweat 9 flows. In the reaction part flow channel 13, the stimulus-responsive gel 14 is provided. The reaction part flow channel 13 has a streamlined shape. At this time, the sweat 9 flows against a small resistance, and therefore, the sweat 9 can be made to flow by a small pressure difference.

(7) According to this embodiment, in the concave part 10, the air intake hole 29 through which outside air passes is provided. When the transport part 27 transports the sweat 9 located in the concave part 10 to the stimulus-responsive gel 14, outside air enters the concave part 10. Accordingly, the atmospheric pressure in the concave part 10 does not decrease, and therefore, the transport part 27 can easily transport the sweat 9 to the stimulus-responsive gel 14.

(8) According to the component concentration estimation method of this embodiment, the stimulus-responsive gel 14 is in the form of a gel, and absorbs the sweat 9. Then, the stimulus-responsive gel 14 reacts with lactic acid contained in the sweat 9. The stimulus-responsive gel 14 reacts with lactic acid and changes its impedance. The sweat 9 is supplied to this stimulus-responsive gel 14. Then, the impedance of the stimulus-responsive gel 14 is detected. By detecting the impedance, the degree at which the stimulus-responsive gel 14 reacts with lactic acid can be detected.

When the concentration of lactic acid contained in the sweat 9 is high, the reaction proceeds more quickly than when the concentration thereof is low, and therefore, the impedance changes more quickly. That is, the speed at which the impedance changes and the concentration of lactic acid contained in the sweat 9 have a predetermined correlation. The concentration estimation part 64 detects the speed at which the impedance changes from the time-series change in the impedance and estimates the concentration of lactic acid contained in the sweat 9 from the speed at which the impedance changes. At this time, the concentration estimation part 64 estimates the concentration of lactic acid contained in the sweat 9 before the stimulus-responsive gel 14 completely reacts with the sweat 9. Therefore, the concentration of a lactic acid component contained in the sweat 9 can be estimated in a shorter time than when the stimulus-responsive gel 14 completely reacts with the sweat 9.

### Second Embodiment

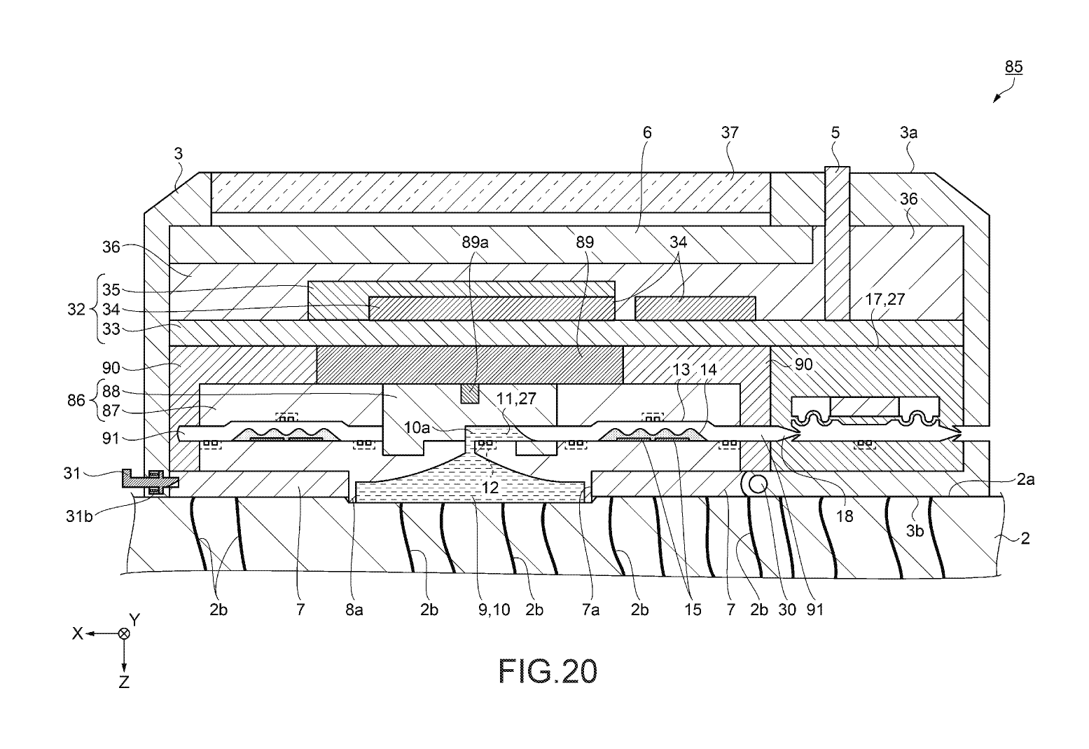

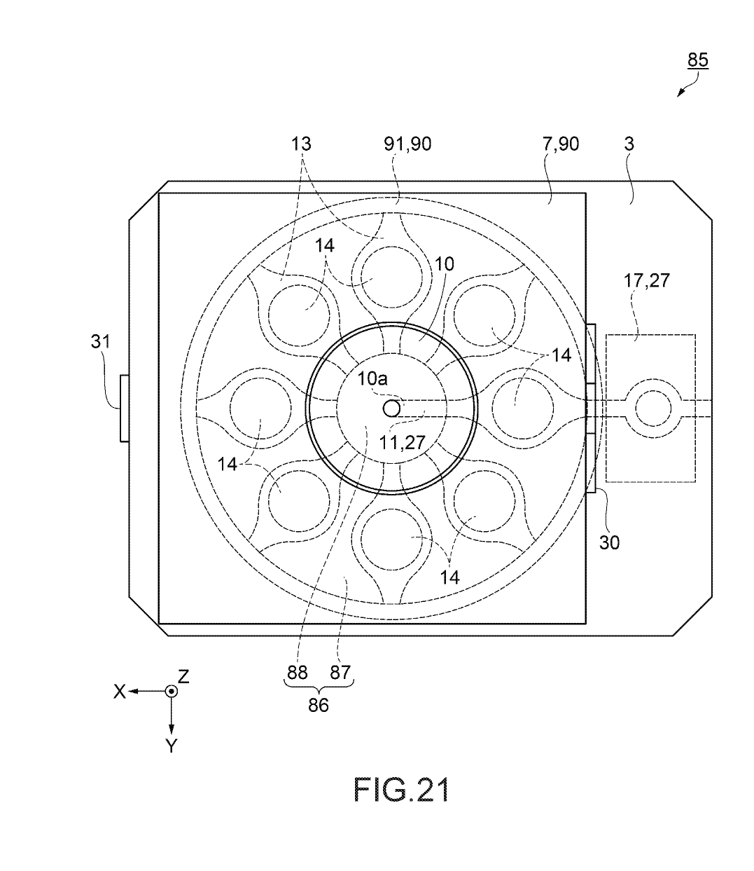

Next, one embodiment of the lactic acid measurement device will be described with reference to FIGS. 20 and 21. FIG. 20 is a schematic side cross-sectional view showing the structure of the lactic acid measurement device. FIG. 21 is a schematic plan view showing the structure of the lactic acid measurement device, and is a view seen from the Z direction side. This embodiment is different from the first embodiment in that a plurality of stimulus-responsive gels are included. A description of the same points as in the first embodiment will be omitted.

That is, in this embodiment, as shown in FIGS. 20 and 21, in a lactic acid measurement device 85 as a gel sensor, a sensor module 86 is provided on the −Z direction side of a back cover 7. The sensor module 86 is constituted by a fixing part 87, a rotating part 88, and the like. On the −Z direction side of the rotating part 88, a motor 89 as a switching part is provided. A rotating shaft 89a of the motor 89 extends in the Z direction and is fixed to the rotating part 88. The motor 89 rotates the rotating part 88 around the Z direction.

On the side surface side and on the −Z direction side of the fixing part 87, a sensor support part 90 which guides and supports the sensor module 86 is provided. In the center of the sensor support part 90, the motor 89 is provided. On the −X direction side of the sensor support part 90, a pump 17 is located.

When the back cover 7 rotates around a hinge 30, the sensor module 86 is exposed. An operator can attach and detach the sensor module 86.

On the +Z direction side of the fixing part 87, a concave part 10 is provided in the center. The concave part 10 is exposed from an opening 7a of the back cover 7. In the rotating part 88, a flow channel connection part 10a and a reaction part upstream flow channel 11 are provided. The flow channel connection part 10a is connected at the center of the concave part 10. In the fixing part 87, a plurality of reaction part flow channels 13 are provided, and in each reaction part flow channel 13, a stimulus-responsive gel 14 is provided. Therefore, in the lactic acid measurement device 85, a plurality of stimulus-responsive gels 14 are provided.

The number of reaction part flow channels 13 and stimulus-responsive gels 14 is not particularly limited, however, in this embodiment, for example, eight reaction part flow channels 13 and eight stimulus-responsive gels 14 are provided. In the sensor support part 90, a reaction part downstream flow channel 91 having a ring shape is provided, and each reaction part flow channel 13 is connected to the reaction part downstream flow channel 91. The reaction part downstream flow channel 91 is also connected to an input part 18 of the pump 17.

In the rotating part 88, one reaction part upstream flow channel 11 is provided. Then, the motor 89 rotates the rotating part 88, and the reaction part upstream flow channel 11 is connected to one reaction part flow channel 13. That is, the motor 89 switches the stimulus-responsive gel 14 to which the sweat 9 is supplied. When the pump 17 is driven, the sweat 9 retained in the concave part 10 is supplied to the stimulus-responsive gel 14 through the flow channel connection part 10a and the reaction part upstream flow channel 11.

The motor 89 is controlled by a CPU 46 provided in a circuit unit 32. The operator operates an operation switch 5, and switches the reaction part flow channel 13 to be connected to the reaction part upstream flow channel 11. By doing this, the operator can switch the stimulus-responsive gel 14 to which the sweat 9 is supplied. After the concentration of lactic acid contained in the sweat 9 is measured using the stimulus-responsive gel 14, the stimulus-responsive gel 14 to which the sweat 9 is supplied is switched to an unused stimulus-responsive gel 14. By doing this, the concentration of lactic acid can be measured 8 times without replacing the sensor module 86.

As described above, according to this embodiment, the following effect is obtained.

(1) According to this embodiment, in the lactic acid measurement device 85, a plurality of stimulus-responsive gels are provided. The lactic acid measurement device 85 includes the motor 89, and the motor 89 switches the stimulus-responsive gel 14 to which the sweat 9 is supplied. Therefore, the lactic acid measurement device 85 can detect the concentration of lactic acid contained in the sweat 9 a plurality of times without replacing the stimulus-responsive gel 14.

This embodiment is not limited to the above-mentioned embodiment and various changes and modifications can be added by a person ordinarily skilled in the art within the scope of the technical idea of the present invention. Hereinafter, modification examples will be described.

### Modification Example 1

In the above-mentioned first embodiment, the stimulus-responsive gel 14 reacts with lactic acid and changes its impedance. Then, by detecting the impedance, the concentration of lactic acid is measured. When boronic acid is contained in the component of the stimulus-responsive gel 14, the stimulus-responsive gel 14 changes by binding to glucose. Therefore, the concentration of glucose may be detected by allowing the sweat 9 when the test subject 2 does not exercise to react with the stimulus-responsive gel 14. A test for diabetes can be performed noninvasively. Then, by detecting the change in the impedance of the stimulus-responsive gel, glucose can be detected in a short time.

Other than these, a gel in which an enzyme such as a glucose oxidase or a urease is fixed to a copolymer gel composed of N-isopropylacrylamide, acrylic acid, and vinyl imidazole is used in place of the stimulus-responsive gel 14. At this time, the stimulus-responsive gel changes by reacting with glucose or urea. Therefore, a test for urea can be performed noninvasively. By detecting the change in the impedance of the stimulus-responsive gel, urea can be detected in a short time.

Other than these, the invention can be applied to the detection of a tumor. A glycoprotein which can be used as a tumor marker is used as a target molecule, and a gel is synthesized using a monomer having lectin capable of recognizing a sugar chain for a sugar chain moiety of the glycoprotein. Alternatively, a gel is synthesized using a monomer having an antibody capable of recognizing a protein for a protein moiety of a glycoprotein which can be used as a tumor marker. Such a synthesized gel is used in place of the stimulus-responsive gel 14. At this time, when a tumor marker is contained in the sweat 9, a crosslinking point which has a three-dimensional network form and acts on both of lectin and the antibody is formed. Then, by the formation of this crosslinking point, the stimulus-responsive gel responds to the tumor marker and contracts. At this time, by detecting the change in the impedance of the stimulus-responsive gel, a tumor can be detected in a short time.

Other than these, the lactic acid measurement device 1 can be used as a cell culture monitor. Cultured cells produce lactic acid as a metabolic component. When lactic acid is accumulated in a culture solution, the culture solution turns acidic, and therefore, the cultured cells are damaged. In the cultivation in the past, a solution of phenol red was added to the culture solution in advance, and the pH of the culture solution was confirmed by the color. When the culture solution turned acidic, the original red color turned yellow, and therefore, the culture medium was replaced based on the change in the color. By using the stimulus-responsive gel 14 as a method for detecting the pH of the culture solution, the effect of phenol red on cells can be suppressed. At this time, by detecting the change in the impedance of the stimulus-responsive gel 14, the pH of the culture solution can be detected in a short time.

Other than these, the lactic acid measurement device 1 can be used as a lactic acid fermentation monitor. Lactic acid fermentation is used for Tsukemono (Japanese pickles) and yogurt. Lactic acid fermentation is a form of fermentation which occurs in bacteria or animal cells in the absence of oxygen, and one glucose molecule is converted to two lactic acid molecules through lactic acid fermentation. Lactic acid produced by lactic acid fermentation is detected by the stimulus-responsive gel 14, and the timing when the fermentation is completed can be controlled by determining the degree of fermentation. At this time, by detecting the change in the impedance of the stimulus-responsive gel 14, the degree of fermentation can be detected in a short time.

Other than these, a stimulus-responsive gel which reacts with a substance such as sodium chloride, potassium chloride, magnesium, a blood cell, a virus, a bacterium, a protein, an allergen such as pollen, a poison, a toxic substance, or an environmental pollutant may be used. The concentration of a substance with which the stimulus-responsive gel reacts can be detected. A solvent for the substance with which the stimulus-responsive gel reacts is not limited to the sweat 9, and a variety of solutions can be used as a test subject. For example, the concentration of a specific substance contained in blood, saliva, urine, or tear can be detected.

### Modification Example 2

In the above-mentioned first embodiment, the lactic acid measurement device 1 is a device to be carried. However, it may be a device to be placed on a desk. Then, an operator may supply a test liquid to the lactic acid measurement device.

### Modification Example 3

In the above-mentioned first embodiment, the air intake hole 29 is a hole which communicates with the side surface of the outer package part 3 from the concave part 10. However, the air intake hole 29 may be a groove provided along the back cover 7. Then, a groove may be formed also on the side wall 8a and a side surface of the outer package part 3 so that outside air can enter the concave part 10. Also at this time, the pressure in the concave part 10 is not reduced, and therefore, the transport part 27 can easily transport the sweat 9 to the reaction part flow channel 13.

### Modification Example 4

In the above-mentioned first embodiment, as shown in FIG. 17, the time between the first time point 74 and the second time point 76 is defined as the measurement elapsed time 77. Other than this, two determination values of the impedance are provided, and a time required for changing between these two determination values may be defined as “measurement elapsed time 77”. When the fall of the shifting line 73 changes, the measurement elapsed time 77 can be accurately measured. Further, the first supply detection part 42 and the second supply detection part 43 can be omitted, and therefore, the lactic acid measurement device 1 can be produced with high productivity.

### Modification Example 5

In the above-mentioned first embodiment, irregularities are provided on the stimulus-responsive gel 14. When the sweat 9 permeates the stimulus-responsive gel 14 in a short time, the irregularities may be omitted. The step of forming the irregularities on the stimulus-responsive gel 14 can be eliminated.

### Modification Example 6

In the above-mentioned first embodiment, the A/D conversion part 49 outputs the digital data signal converted at predetermined time intervals. Other than this, the impedance measurement part 48 may change the measurement time interval. The impedance measurement part 48 may have a timepiece function, and the A/D conversion part 49 may output the signals of the measurement data and the measurement time data. Also at this time, the concentration estimation part 64 can estimate the concentration of lactic acid contained in the sweat 9. Then, by setting the measurement time interval when the change in the impedance is large shorter than the measurement time interval when the change in the impedance is small, the number of pieces of data can be reduced. Since the number of pieces of data to be utilized for estimating the concentration of lactic acid contained in the sweat 9 can be increased, and therefore, the concentration of lactic acid contained in the sweat 9 can be accurately estimated.

### Modification Example 7

In the above-mentioned second embodiment, in the rotating part 88, one reaction part upstream flow channel 11 is provided. However, in the rotating part 88, a plurality of reaction part upstream flow channels 11 may be provided. Then, the stimulus-responsive gels 14 which react with different components are placed, and the sweat 9 may be supplied to the respective stimulus-responsive gels 14 simultaneously. The concentrations of a plurality of components can be tested simultaneously.

The entire disclosure of Japanese Patent Application No. 2016-162490 filed Aug. 23, 2016 is expressly incorporated by reference herein.

What is claimed is:

1. A gel sensor, comprising:
a reaction part in the form of a gel which reacts with a predetermined component contained in a test liquid and changes its electrical property;
an electrical property detection part which detects the electrical property of the reaction part; and
a concentration estimation part which estimates the concentration of the predetermined component contained in the test liquid from the time-series change in the electrical property.

2. The gel sensor according to claim 1, wherein the gel sensor includes a supply detection part which detects whether or not the test liquid is supplied to the reaction part.

3. The gel sensor according to claim 1, wherein irregularities are provided on the surface of the reaction part.

4. The gel sensor according to claim 1, wherein
the gel sensor includes
a recovery part which recovers the test liquid, and
a transport part which transports the test liquid to the reaction part from the recovery part, and
the recovery part includes a recovery detection part which detects whether or not the test liquid is recovered.

5. The gel sensor according to claim 4, wherein the gel sensor includes a passage detection part which detects whether or not a portion of the test liquid supplied to the reaction part passes through the reaction part.

6. The gel sensor according to claim 1, wherein
the gel sensor includes a flow channel, in which the reaction part is placed, and through which the test liquid flows, and
the flow channel has a streamlined shape.

7. The gel sensor according to claim 4, wherein the recovery part includes an air intake hole through which outside air passes.

8. The gel sensor according to claim 1, wherein
a plurality of reaction parts are provided, and
a switching part which switches the reaction part to which the test liquid is supplied is included.

9. A component concentration estimation method, comprising:
supplying a test liquid to a reaction part in the form of a gel which reacts with a predetermined component contained in the test liquid and changes its electrical property;
detecting the electrical property of the reaction part; and
estimating the concentration of the predetermined component contained in the test liquid from the time-series change in the electrical property.
